(19) United States
(12) Patent Application Publication
(10) Pub. No.: US 2016/0167222 A1
(43) Pub. Date: Jun. 16, 2016

(54) INSTRUCTIONAL HUMANOID ROBOT APPARATUS AND A METHOD THEREOF

(71) Applicant: Nimer Mohammed Ead, Providence, RI (US)

(72) Inventor: Nimer Mohammed Ead, Providence, RI (US)

(21) Appl. No.: 15/051,451

(22) Filed: Feb. 23, 2016

Related U.S. Application Data
(63) Continuation-in-part of application No. 14/984,336, filed on Dec. 30, 2015.
Application No. 14/984,336 is a continuation of application No. 13/566,970, filed on Aug. 3, 2012, now abandoned.

(51) Int. Cl. B25J 9/00; B25J 13/00

(52) U.S. Cl. CPC B25J 9/0006; B25J 13/003

(57) ABSTRACT

The present invention relates generally to an instructional humanoid robot. More particularly, the invention encompasses an apparatus and a method for having an instructional robot which is capable of physically and instructionally demonstrating the correct manner of performing the Islamic prayer and similar other Islamic or Muslim teachings. The instructional humanoid robot can also be programmed to perform any teaching or instructions as desired by the user or an operator. The instructional humanoid robot can also be preprogrammed to perform certain functions via the aid of a computer or similar device. The instructional humanoid robot can also be interactive via instructions and information accessed from a library, databank or similar other program storage device.

### FIELD OF THE INVENTION

The present invention relates generally to an instructional humanoid robot. More particularly, the invention encompasses an apparatus and a method for having an instructional robot which is capable of physically and instructionally demonstrating the correct manner of performing the Islamic prayer and similar other Islamic or Muslim teachings. The instructional humanoid robot can also be programmed to perform any teaching or instructions as desired by the user or an operator. The instructional humanoid robot can also be preprogrammed to perform certain functions via the aid of a computer or similar device. The instructional humanoid robot can also be interactive via instructions and information accessed from a library, databank or similar other program storage device.

### BACKGROUND INFORMATION

Robots take on many different forms, ranging from humanoid, which mimic the human form and way of moving, to industrial, whose appearance is dictated by the function they are to perform. Robots are growing in complexity and their use in industry and daily life is becoming more widespread.

The development of a robot with natural human movements has only recently become a reality. Now that background technologies of behavior, navigation and path planning have been solved using basic wheeled robots, engineers are moving on to develop walking robots such as, for example, Honda's ASIMO (Advanced Step in Innovated MObility) (2000), Sony's QRIO (“Quest for cuRIOsity” otherwise known as the “Sony Dream Robot” or “SDR”) (2006), The Korea Advanced Institute of Science and Technology's (KAIST's) HUBO (KHR-3) (2005), to name a few, which can move in a very humanlike manner.

In recent times the robotic industry has been steadily moving towards developing more sophisticated consumer robots, and such robots now assist people in many areas.

U.S. Pat. No. 5,100,138 (Mark S. Wilde), the entire disclosure of which is incorporated herein by reference, discloses a motorized mobile robot which is articulated and controlled by joysticks and foot pedals or by remote control to simulate the sport of boxing by effecting punches and blocks upon a like robot. Fluid motor driven wheels propel the robot in forward, rearward, lateral, turning, and spinning movements. An upper frame above the wheel base defines an enclosure having a generally humanoid configuration including a torso with an interior seat for supporting a person within the enclosure in a sitting position. A pair of independently movable arm assemblies connected at each side of the torso are driven by fluid actuators and each has a shoulder portion pivotally movable relative to the torso, an upper arm portion pivotally movable relative to the shoulder portion, and a forearm portion pivotally movable relative to the upper arm portion with a padded boxing glove at the outer end. A head member is movably mounted on the torso and a scoreboard on the torso indicates the number of times the head has been pivoted rearwardly by blows delivered by an opponent to determine the winner of a boxing match. A proximity control allows arm movement only when one robot is in a predetermined position relative to a like robot.

U.S. Pat. No. 6,583,595 (Yuichi Hattori, et al.), the entire disclosure of which is incorporated herein by reference, discloses a humanoid robot including upper limbs, lower limbs, and a trunk. Hip joints which connect the lower limbs and the trunk each possess degrees of freedom provided in correspondence with a hip joint yaw axis, a hip joint roll axis, and a hip joint pitch axis. The humanoid robot is a leg-movement-type robot which walks on two feet. By arbitrarily offsetting the hip joint yaw axes in a roll axis direction, the effects of the movement of the center of gravity occurring when the mode of use of the robot is changed are accommodated to in order to flexibly balance the weights of the upper and lower limbs. The waist is made more compact in order to form a humanoid robot which is well proportioned and which makes it possible to prevent interference between the left and right feet when the direction of a foot is changed. Accordingly, a robot which moves naturally and in a way sufficiently indicative of emotions and feelings using fewer degrees of freedom is provided.

U.S. Pat. No. 7,057,367 (Takayuki Furuta, et al.), the entire disclosure of which is incorporated herein by reference, discloses a biped (two-footed) walking humanoid robot, which is provided with drive motors (11d, 11e, 18L, 18R-24L, 24R, 28L, 28R-33L, 33R, 35, 36) to pivotally move respective joint portions, and a motion control apparatus (40) to drive-control respective drive motors, and said motion control apparatus (40), together with a detector (45) to detect the robot's current posture and others, compares the robot's detected current posture and others with next motion command input from outside, and if next motion command is within the range of stability limit with respect to the robot's current posture and others, the complementary data with respect to intermediate motion from current posture till initial posture of next motion command and the motion data corresponding to next motion command are generated, each drive motor is drive-controlled based on said complementary and motion data, and thereby various motions are conducted smoothly and continually. It is preferably provided with a motion library (41a) storing time series data of basic motions as the elements of the robot's motions and posture data consisting of algorithm, reads out the corresponding posture data from said motion library, and generates complementary and motion data as the combined motion sequence.

U.S. Patent Publication No. 20110067521 (Douglas Martin Linn, et al.), the entire disclosure of which is incorporated herein by reference, discloses a humanoid robot which includes a torso, a pair of arms, two hands, a neck, and a head. The torso extends along a primary axis and presents a pair of shoulders. The pair of arms movably extend from a respective one of the pair of shoulders. Each of the arms has a plurality of arm joints. The neck movably extends from the torso along the primary axis. The neck has at least one neck joint. The head movably extends from the neck along the primary axis. The head has at least one head joint. The shoulders are canted toward one another at a shrug angle that is defined between each of the shoulders such that a workspace is defined between the shoulders.

U.S. Patent Publication No. 20110071673 (Chris A. Ihrke, et al.), the entire disclosure of which is incorporated herein by reference, discloses a lower arm assembly for a humanoid robot includes an arm support having a first side and a second side, a plurality of wrist actuators mounted to the first side of the arm support, a plurality of finger actuators mounted to the second side of the arm support and a plurality of electronics also located on the first side of the arm support.

This invention overcomes the problems of the prior art with the inventive instructional humanoid robot of this invention.

### PURPOSES AND SUMMARY OF THE INVENTION

The invention is a novel method and an apparatus comprising an instructional humanoid robot.

Therefore, one purpose of this invention is to have a unique instructional humanoid robot.

Another purpose of this invention is to have an instructional humanoid robot that is capable of demonstrating the correct manner of performing and providing instructions for the various Islamic prayers and related instructions.

Yet another purpose of this invention is to is to have an instructional humanoid robot that is capable of demonstrating and teaching and providing instructions as desired by the user and/or operator and related instructions.

Yet another purpose of this invention is to provide an instructional humanoid robot that is interactive and can interact with both adults and children, and also interact with people of all diverse backgrounds, religions, and nationalities.

Therefore, in one aspect this invention comprises an instructional humanoid robot for teaching and performing a set of instructions, comprises:

(a) a humanoid body, comprising a torso having a right leg, a left leg, a right arm, a left arm secured thereto, and a head connected to said torso via a neck;

(b) at least one first means in said head to move said head laterally from a first position to a second position, wherein said first position and said second position are approximately 180 degrees from each other, at least one second means in said head to move said head vertically from a third position to a fourth position so as to form a nodding movement;

(c) at least one means in said torso to connect to said right arm, so as to provide humanoid-type movement to said right arm;

(d) at least one means in said torso to connect to said left arm, so as to provide humanoid-type movement to said left arm;

(e) at least one means in said torso to connect to said right leg, so as to provide humanoid-type movement to said right leg;

(f) at least one means in said torso to connect to said left leg, so as to provide humanoid-type movement to said left leg;

(g) at least one means secured to a right foot of said right leg so as to provide human-like pivoting movement to said right foot;

(h) at least one means secured to a left foot of said left leg so as to provide human-like pivoting movement to said left foot; and

(i) at least one means in said torso to move components connected to said torso in human-like positions, and thereby forming said instructional humanoid robot, for teaching and performing a set of instructions.

In another aspect this invention comprises a method for teaching and performing a set of instructions using an instructional humanoid robot comprising:

(a) at least one means for instructing said humanoid robot to raise both arms from a first position to a second position while said humanoid robot is in a standing position, wherein in said first position said arms are along a side of said humanoid robot, and wherein in said second position each hand of said arm are substantially adjacent to a corresponding ear for each hand of said arms;

(b) at least one means to move said arms from said second position to a third position, wherein said third position is over a chest area of said humanoid robot, such that a portion of a right hand is over a portion of a left hand;

(c) at least one means to move said hands from said third position back to said first position;

(d) at least one means to move said hands from said first position to a fourth position, wherein said fourth position allows the placement of said right hand onto a portion of a right knee, while said left hand is placed along a portion of a left knee, and forming a bowing posture;

(e) at least one means to move said hands from said fourth position back to said first position;

(f) at least one means to move said hands from said first position to a fifth position, wherein said fifth position places said humanoid robot from said standing position to a prostrating position on a ground, such that a portion of the face, said hand, said knees, and foot are all on the ground and substantially planer to said ground;

(g) at least one means to move said humanoid robot from said fifth position to a sixth position, wherein said sixth position allows said humanoid robot to be in a sitting position such that said foot and said knees are on the ground while a portion of the hips are resting on a portion of said foot, and the chest area is in a substantially erect position, and wherein said hands are over a corresponding thigh portion of said humanoid robot; and

(h) at least one means to move said humanoid robot from said sixth position back to said first position.

In still yet another aspect this invention comprises a program storage device readable by machine, tangibly embodying a program of instructions executable by the machine to perform method steps for an instructional humanoid robot for teaching and performing a set of instructions, the method steps comprising:

(a) at least one means for instructing said humanoid robot to raise both arms from a first position to a second position while said humanoid robot is in a standing position, wherein in said first position said arms are along a side of said humanoid robot, and wherein in said second position each hand of said arm are substantially adjacent to a corresponding ear for each hand of said arms;

(b) at least one means to move said arms from said second position to a third position, wherein said third position is over a chest area of said humanoid robot, such that a portion of a right hand is over a portion of a left hand;

(c) at least one means to move said hands from said third position back to said first position;

(d) at least one means to move said hands from said first position to a fourth position, wherein said fourth position allows the placement of said right hand onto a portion of a right knee, while said left hand is placed along a portion of a left knee, and forming a bowing posture;

(e) at least one means to move said hands from said fourth position back to said first position;

(f) at least one means to move said hands from said first position to a fifth position, wherein said fifth position places said humanoid robot from said standing position to a prostrating position on a ground, such that a portion of the face, said hand, said knees, and foot are all on the ground and substantially planer to said ground;

(g) at least one means to move said humanoid robot from said fifth position to a sixth position, wherein said sixth position allows said humanoid robot to be in a sitting position such that said foot and said knees are on the ground while a portion of the hips are resting on a portion of said foot, and the chest area is in a substantially erect position, and wherein said hands are over a corresponding thigh portion of said humanoid robot; and

(h) at least one means to move said humanoid robot from said sixth position back to said first position.

### BRIEF DESCRIPTION OF THE DRAWINGS

The features of the invention believed to be novel and the elements characteristic of the invention are set forth with particularity in the appended claims. The drawings are for illustration purposes only and are not drawn to scale. Furthermore, like numbers represent like features in the drawings. The invention itself, both as to organization and method of operation, may best be understood by reference to the detailed description which follows taken in conjunction with the accompanying drawings in which:

FIG. 1 is a front perspective view of an instructional humanoid robot according to the present invention as one form of embodiment thereof, wherein both interior and external components are visible.

FIG. 2A is a front view of the upper half of the instructional humanoid robot in a hands raised position.

FIG. 2B is a front view of the upper half of the instructional humanoid robot in a hands lowered to the side of body position.

FIG. 2C is a front view of the upper half of the instructional humanoid robot in a hands over the chest position.

FIG. 3A is a left side view of the right lower arm, hand and index finger of the instructional humanoid robot in a planar position.

FIG. 3B is a left side view of the right lower arm, hand and index finger of the instructional humanoid robot with the index finger in a raised position.

FIG. 4 is a block diagram explaining an action decision process by a CPU.

FIG. 5 is a block diagram showing the circuit configuration of the instructional humanoid robot according to one embodiment of the invention.

FIG. 6A is a front perspective view showing a Muslim beginning the prayer in a standing position with hands raised which the instructional humanoid robot will mimic.

FIG. 6B is a front perspective view showing a Muslim praying in a standing position with hands crossed over the torso which the instructional humanoid robot will mimic.

FIG. 6C is a front perspective view showing a Muslim praying in a bowing position with hands placed on knees which the instructional humanoid robot will mimic.

FIG. 6D is a front perspective view showing a Muslim praying in a standing position with hands resting at sides which the instructional humanoid robot will mimic.

FIG. 6E is a front perspective view showing a Muslim praying in a prostrating position which the instructional humanoid robot will mimic.

FIG. 6F is a front perspective view showing a Muslim praying in a sitting position which the instructional humanoid robot will mimic.

FIG. 6G is a front perspective view showing a Muslim praying in a prostrating position which the instructional humanoid robot will mimic.

FIG. 6H is a front perspective view showing a Muslim praying in a sitting position which the instructional humanoid robot will mimic.

FIG. 6I is a front perspective view showing a Muslim praying in a sitting position with the head turned fully to the right which the instructional humanoid robot will mimic.

FIG. 6J is a front perspective view showing a Muslim praying in a sitting position with the head turned fully to the left which the instructional humanoid robot will mimic.

FIG. 7 is a block diagram showing an Islamic prayer sequence which the instructional humanoid robot will demonstrate.

FIG. 8A is a front view of the head and neck of the instructional humanoid robot with the head facing forward.

FIG. 8B is a front view of the head and neck of the instructional humanoid robot with the head turned to the right side.

FIG. 8C is a front view of the head and neck of the instructional humanoid robot with the head turned to the left side.

FIG. 9 is a front perspective view of the detachable and foldable screen that is attached to the base of the instructional humanoid robot.

FIG. 10A is a front perspective view showing a Muslim male praying in a standing position with hands raised which the instructional humanoid robot will mimic, wearing a robe and a head covering.

FIG. 10B is a front perspective view showing a Muslim female praying in a standing position with hands raised which the instructional humanoid robot will mimic, wearing a dress and head covering.

FIG. 11A is a front view of the head and neck of the instructional humanoid robot with the head facing forward.

FIG. 11B is a front view of the head and neck of the instructional humanoid robot with the head facing forward.

FIG. 12 is a side profile view of the instructional humanoid robot in a hands-raised position.

FIG. 13A is a top elevation view of an instructional humanoid robot in accordance to one embodiment of the present invention in which the mechanisms of the torso and arms are enlarged to show a method of crossing the arms in and out.

FIG. 13B is a top elevation view of an instructional humanoid robot in accordance to one embodiment of the present invention in which the mechanisms of the torso and arms are enlarged to show a method of raising the arms up and down using the same cam setup with one cable for both motions in FIGS. 13A and 13B.

FIG. 14 is a top elevation view of an instructional humanoid robot in accordance to one embodiment of the present invention in which the mechanisms of the right hand, right forearm and right thigh are enlarged to show a method of raising the right index finger using an external magnet on the index finger and an external magnet on the thigh.

FIG. 15 is a side elevation cross-sectional view of an instructional humanoid robot in accordance to one embodiment of the present invention in which the mechanisms of the right hand, right arm and right thigh are enlarged to show a method of raising the right index finger using an electric coil inside the palm of the hand and steel piece inside the thigh.

FIG. 16 is a side elevation cross-sectional view of an instructional humanoid robot in accordance to one embodiment of the present invention in which the mechanisms of the right hand, right arm and right thigh are enlarged to show a method of raising the right index finger using a steel piece inside the palm of the hand and a magnet inside the thigh.

FIG. 17 is a top elevation cross-sectional view of an instructional humanoid robot in accordance to one embodiment of the present invention in which the mechanisms of the right hand, right arm and right thigh are enlarged to show a method of raising the right index finger using an internal magnetic coil in the index finger and an external magnet middle finger portion of the hand.

FIG. 18A is a side cross-sectional view of an instructional humanoid robot in accordance to one embodiment of the present invention in which the mechanisms of the right hand, right arm and right thigh are enlarged to show a method of raising the right index finger using a muscle wire connected to the back of the index finger and the back of the palm inside the hand.

FIG. 18B is a side cross-sectional view of an instructional humanoid robot in accordance to one embodiment of the present invention in which the mechanisms of the right hand, right arm and right thigh are enlarged to show a method of raising the right index finger using a muscle wire connected to the back of the index finger and the back of the palm inside the hand.

FIG. 19 is side elevation view of an instructional humanoid robot in accordance to one embodiment of the present invention in which the mechanisms of the left thigh, left lower leg and left foot are enlarged to show a method of turning the left foot underneath the instructional humanoid robot using the thigh to mechanically actuate the left lower leg to turn the left foot.

FIG. 20 is side elevation view of an instructional humanoid robot in accordance to one embodiment of the present invention in which the mechanisms of the left thigh, left lower leg and left foot are enlarged to show a method of turning the left foot underneath the instructional humanoid robot using the a magnet in the thigh and a steel piece in the left lower leg to magnetically actuate the left lower leg to turn the left foot.

FIG. 21A is side elevation view of an instructional humanoid robot in accordance to one embodiment of the present invention in which the mechanisms of the left thigh, left lower leg and left foot are enlarged to show a method of turning the left foot underneath the instructional humanoid robot using muscle wire in left lower leg to turn left foot.

FIG. 21B is side elevation view of an instructional humanoid robot in accordance to one embodiment of the present invention in which the mechanisms of the left thigh, left lower leg and left foot are enlarged to show a method of turning the left foot underneath the instructional humanoid robot using muscle wire in left lower leg to turn left foot.

### DETAILED DESCRIPTION

In order to attain the objectives mentioned above, there is provided in accordance with the present invention, an instructional humanoid robot, which includes a torso, a pair of legs attached to the lower part of the torso at a pair of its opposite sides, respectively, a pair of arms attached to the upper part of the torso at a pair of its opposite sides, respectively, a head attached to the neck so as to be pivotally movable relative thereto monoaxially, and neck attached to the torso so as to be pivotally movable relative thereto mono-axially, wherein each of the legs includes an upper leg attached to the torso so as to be pivotally movable relative thereto monoaxially, a lower leg attached to the upper leg so as to be pivotally movable relative thereto monoaxially, a foot attached to the lower leg so as to be pivotally movable relative thereto monoaxially, a toe attached to the foot so as to be pivotally movable relative thereto monoaxially, and a base attached to the toe so as to be pivotally movable relative thereto monoaxially, wherein each of the arms includes an upper arm attached to the upper part of the torso so as to be pivotally movable relative thereto bi-axially, a lower arm attached to the upper arm so as to be pivotally movable relative thereto monoaxially, a hand attached to the lower arm so as to be pivotally movable relative thereto monoaxially, and an index finger attached to the right hand so as to be pivotally movable relative thereto monoaxially; and wherein the robot further comprises a drive means for pivotally moving the instructional humanoid robot apparatus into a standing, bowing, prostrating and sitting position.

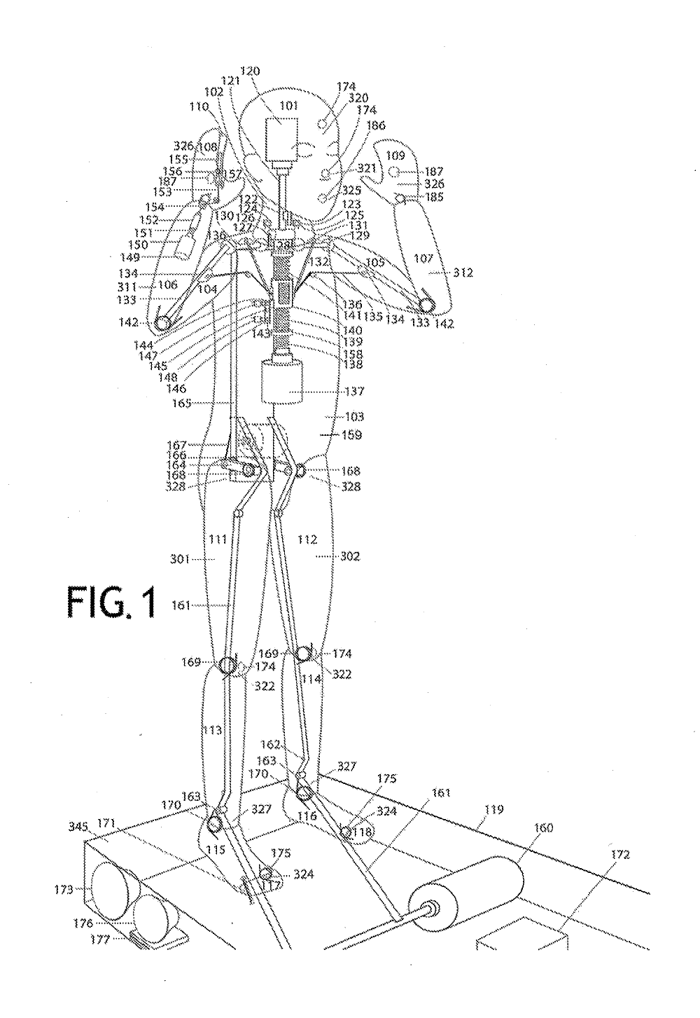

Referring now to the Figure, where FIG. 1 is a front perspective view of an instructional humanoid robot 159, according to the present invention as one form of embodiment thereof, wherein both interior and external components are visible. Referring to FIG. 1, the instructional humanoid robot 159, includes a torso 103, a head 101 and neck 102, a pair of legs 301, 302, a pair of arms 311, 312, and a base 119. The head 101 is attached to the neck 102 so as to be pivotally movable, and neck 102 is attached to the torso 103 so as to be pivotally movable relative thereto, wherein the legs 301, 302, are comprised of a right upper leg 111 and a left upper leg 112 attached to the lower part of the torso 103 so as to be pivotally movable relative thereto, a right lower leg 113 and a left lower leg 114 attached to the right upper leg 111 and the left upper leg 112, respectively, so as to be pivotally movable relative thereto, a right foot 115 and a left foot 116 attached to the right lower leg 113 and left lower leg 114, respectively, so as to be pivotally movable relative thereto, a right toe 117 and a left toe 118 attached to the right foot 115 an left foot 116, respectively, so as to be pivotally movable relative thereto, and a base 119 attached to the right toe 117 and left toe 118 so as to be pivotally movable relative thereto, wherein each of the arms 311, 312, includes a right upper arm 104 and a left upper arm 105 attached to the upper part of the torso 103 so as to be pivotally movable relative thereto, a right lower arm 106 and left lower arm 107 attached to the right upper arm 104 and left upper arm 105, respectively, so as to be pivotally movable relative thereto, a right hand 108 and a left hand 109 attached to the right lower arm 106 and the left lower arm 107 so as to be pivotally movable relative thereto, and an index finger 110 attached to the right hand 108 so as to be pivotally movable relative thereto. An elbow torsion spring 142 located between both the right upper arm 104 and the right lower arm 106 and the left upper arm 105 and the left lower arm 107 is used to return both the right lower arm 106 and the left lower arm 107 to their default positions. A series of illumination devices 174, such as, for example, prostration LED lights 174, are located at appropriate or selected locations, such as, for example, at the forehead 320, nose 321, knee 322, and toe 324, regions, to name a few, and are programmed to light up as desired, such as, for example, when the instructional humanoid robot 159 goes into the prostration position when demonstrating the prayer. Another illumination device 186, such as, a mouth LED light 186 is locate in the mouth 325, region of the head 101 of the instructional humanoid robot 159, and is programmed to light up when the speaker 173 is in an audio mode. Illumination device 187, such as, for example, a hand LED lights 187, are located in the palm regions 326, of both the right hand 108 and the left hand 109 and are programmed to light up, as desired, such as, when the instructional humanoid robot 159 goes into the bowing position.

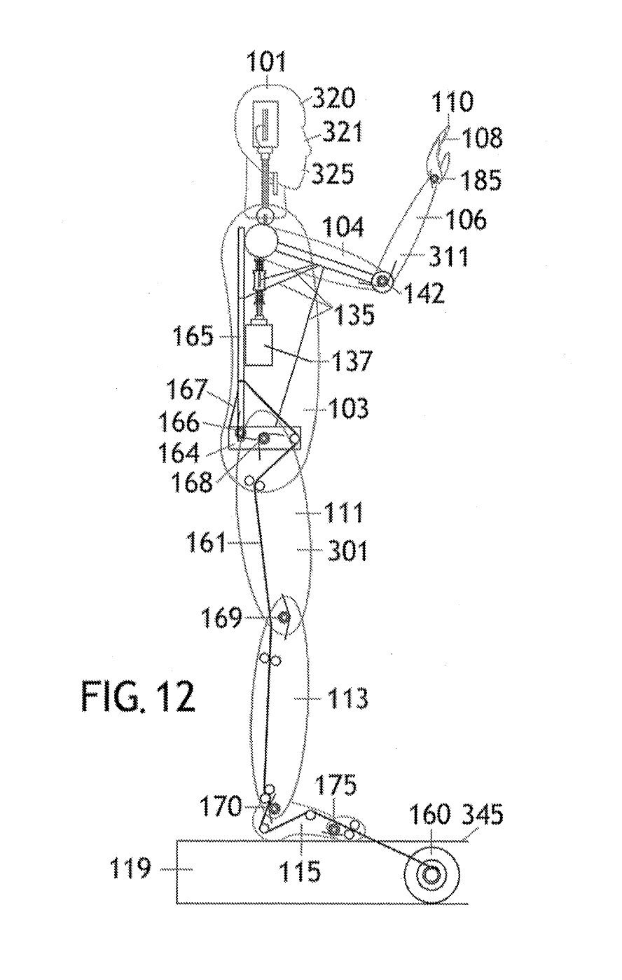

Housed within the base 119 there is located a base motor 160. The base motor 160 is connected to two torque cable 161, guided by fixed pin guides 162 and fixed rollers 163 through the base 119, the right foot 115 and left foot 116, the right lower leg 113 and left lower leg 114, the right upper leg 111 the left upper leg 112 and into the torso 103 where it is attached to the back support (not shown). When the base motor 160 pulls the torque cable 161 begins to bend the legs 301, 302, of the instructional humanoid robot 159, at the toe 324, the ankle 327, the knee 322, and the hip joints 328. As the torque cable 161 is pulled, it pulls the back support board 165 downward, pivoting on the torso pivoting bar 164. As the torque cable 161 continues to be pulled, the upper legs 111, 112, lower legs 113, 114, foot 115, 116, bend at their respective joints, bringing the instructional humanoid robot 159 onto its knees. Further tension on the torque cable 161 will bring the head 101 to the ground. The rate of the rotation of these joints are regulated by a series torsion springs, as discussed elsewhere, with the back support board torsion spring 166 being the weakest, while the hip torsion spring 168, the knee torsion spring 169, the ankle torsion spring 170 and the lastly the toe torsion spring 175 being progressively stronger, as more clearly shown in FIG. 12. This mechanical process enables the instructional humanoid robot 159 to stand, bow and prostrate in a manner similar to those that make up the Islamic prayer. A back support tension elastic 167 attached to both the back support board 165 and the torso pivoting bar 164, in the torso 103, assists the back support board torsion spring 166 return the back support board 165 to its default vertical position. Located within the base 119 there is at least one speaker 173 to play pre-recorded or transmitted audio. At least one microphone 176, such as, for recording audio, at least one USB input 177, such as, for transferring data to a device 172, such as, a CPU 172 may also be housed in the base 119. A toe tension spring 171 attached to both the bottom right foot 115, and the base 119 is used to return the right foot 115 to its default position. In another embodiment, the base motor 160 could be housed inside the torso 103 which would enable the right toe 117 and left toe 118 can become detachable from the base 119. Attached to a master moving collet 140 is an arms controller sensor rod 143 upon which is mounted an upper sensor roller 144, a middle sensor roller 145 and a lower sensor roller 146. An upper sensor switch 147 and a lower sensor switch 148, are preferably adjacent the master moving collet 140.

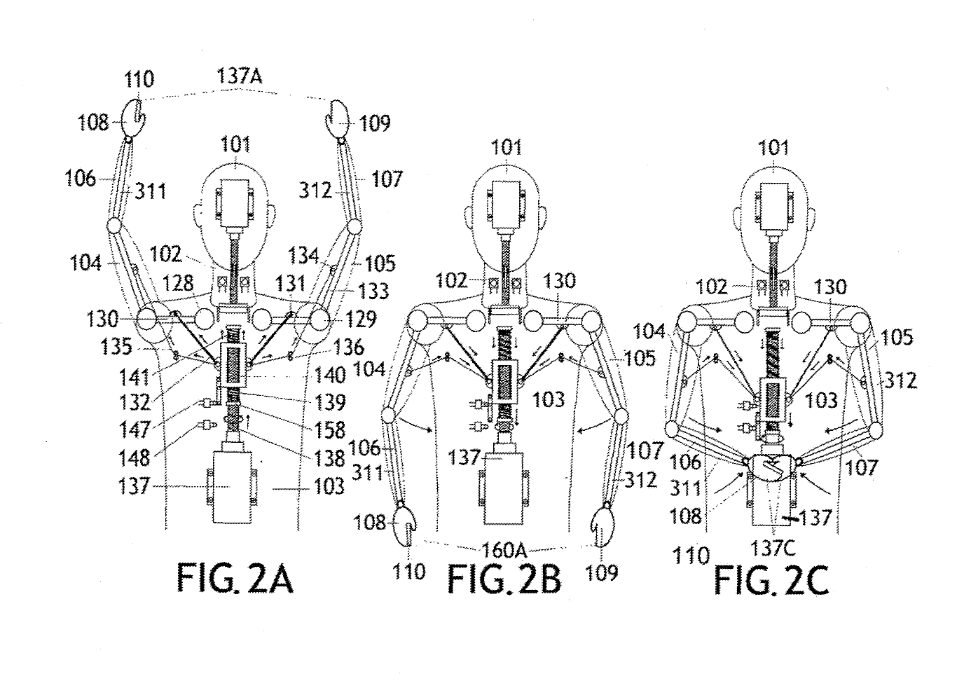

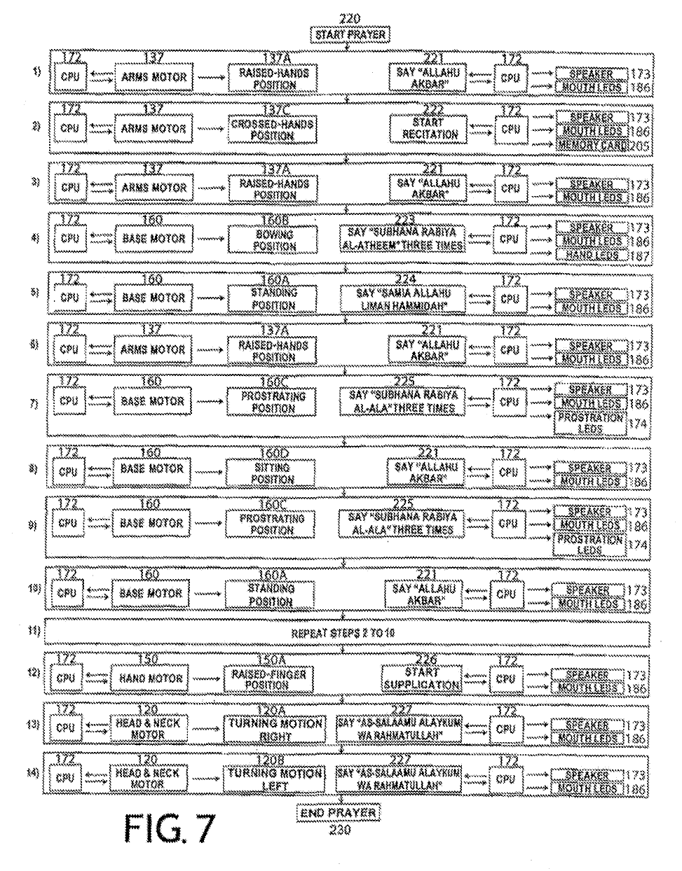

FIG. 2A is a front view of the upper half of the instructional humanoid robot 159, in a hands raised position 137A, while FIG. 2B is a front view of the upper half of the instructional humanoid robot 159, in a hands lowered to the side of body position 160A, and wherein FIG. 2C is a front view of the upper half of the instructional humanoid robot 159, in a hands over the torso position 137C, or the crossed-hands position 137C. Now referring back to FIGS. 2A, 2B, and 2C, where FIG. 2A is a front view of the upper half of the instructional humanoid robot 159, in a hands raised position 137A, wherein there is shown a vertically mounted arms motor 137 housed within the torso 103. Attached to the arms motor 137 is a threaded torso shaft 138 on which a threaded collet 158, a lower compression spring 139, a master moving collet 140 and an upper compression spring 141 are located. Attached to either side of the master moving collet 140 there is a shoulder controller rod 132 and a torso tension elastic 135. Attached to each shoulder controller rod 132 is shoulder bracket 131 that is affixed to a shoulder rod 130 that rotates between a pivoting ball 128 on one end and a shoulder joint 129 on the other. Rotatably attached to the shoulder joint 129 is arm rod 133, that extends through the right upper arm 104 and right lower arm 106, respectively, onto each of which there is affixed an arm bracket 134. Attached to each arm bracket 134 is a torso tension elastic 135, which is attached to the master moving collet 140. Each torso tension elastic 135 is guided by a tension elastic roller 136. As the arms motor 137 rotates clockwise, the threaded collet 158 begins to move up the threaded torso shaft 138 which pushes the lower compression spring 139, the master moving collet 140 and the upper compression spring 141 upwards. As the master moving collet 140 advances up the threaded torso shaft 138, it causes the shoulder controller rods 132 to push the shoulder brackets 131 upwards, which in turn rotates the shoulder rods 130, the shoulder joints 129 and upper arm rods 133 upwards as shown in FIG. 2A. The upwards movement of the master moving collet 140 also lessens the tension being applied to the torso 103 via tension elastics 135, which allows the upper arm rods 133 to move away from the torso 103. When the motor 137, rotates counter-clockwise the threaded collet 158 begins to move down the threaded torso shaft 138 which causes the lower compression spring 139, the master moving collet 140 and the upper compression spring 141 to also descend, or move downwards. As the master moving collet 140 moves down the threaded torso shaft 138, it causes the shoulder controller rods 132 to pull the shoulder brackets 131 downwards, which in turn rotates the shoulder rods 130, the shoulder joints 129 and the upper arm rods 133 downwards, as shown, more clearly in FIG. 2B where the arms 311, 312, have been lowered to the sides of the instructional humanoid robot 159. The downward movement of the master moving collet 140 increases the tension being applied to the torso 103, and torso tension elastics 135, which allows the upper arm rods 133 to be pulled towards the torso 103 and eventually cross the arms 311, 312, over the torso 103, as shown in FIG. 2C. In essence, this mechanical process enables the instructional humanoid robot 159 to raise and lower, extend and retract and cross and uncross its arms over its chest in a manner which closely resembles several of the movements that make up the Islamic prayer. Attached to a master moving collet 140 is an arms controller sensor rod 143 upon which is mounted an upper sensor roller 144, a middle sensor roller 145 and a lower sensor roller 146. An upper sensor switch 147 and a lower sensor switch 148, are preferably adjacent the master moving collet 140. The position of the arms 311, 312, is regulated by the position of sensor rollers 144, 145, 146, in relation to the sensor switches 147, 148, and the pre-programmed settings of the CPU 172 as shown in FIG. 1 and explained in detail in FIG. 7B.

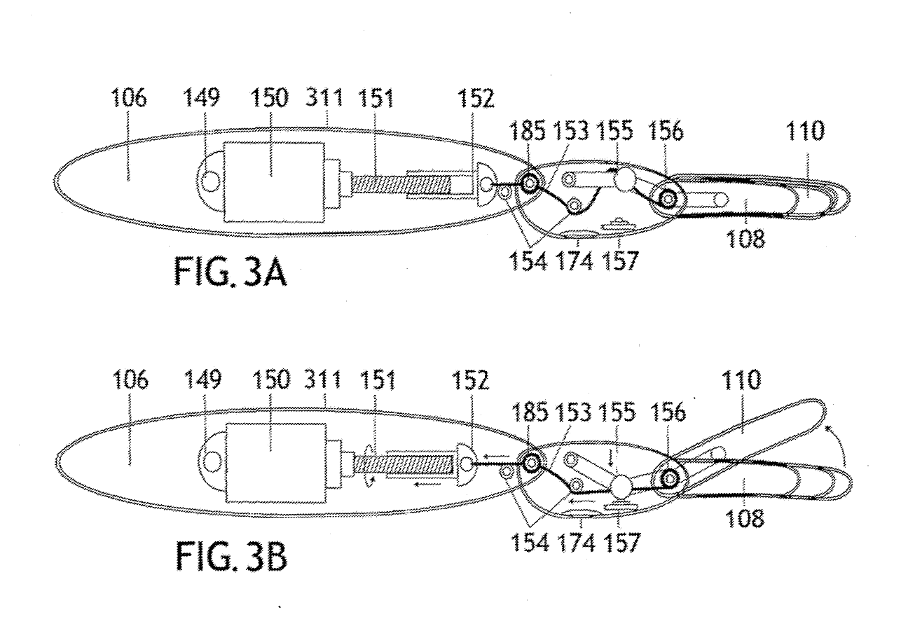

FIG. 3A is a left side view of the right lower arm 106, hand 108, and index finger 110, of the instructional humanoid robot 159, in a planar position, and where FIG. 3B is a left side view of the right lower arm 106, hand 108, index finger 110, of the instructional humanoid robot 159, with the index finger 110, in a raised-finger position 150A. Referring to FIGS. 3A and 3B there is shown a lower arm motor 150, a threaded arm shaft 151 and a threaded cable holder 152 housed within the right lower arm 106. Located along the back side of the lower arm motor 150 is the lower arm motor pivoting point 149 which allows the motor to pivot between about 0 degrees to about 20 degrees, and preferably between about 15 to about 20 degrees. As the lower arm motor 150 rotates the threaded arm shaft 151 clockwise, the threaded cable holder 152 extends, pushing the finger cable 153 forward, which in turn pushes the finger controller rod 155 upwards and lifts the index finger 110 as shown in FIG. 3B. When the lower arm motor 150 rotates the threaded arm shaft 151 counter-clockwise, the threaded cable holder 152 retracts, pulling the finger cable 153 backwards, which in turn pulls the finger controller rod 155 downwards and places the index finger 110 back down as shown in FIG. 3A. Fixed finger cable 153 rollers 154 are used to guide the finger cable 153. An index finger torsion spring 156 is used to return the finger controller rod 155 back to its default position. A magnetic sensor switch 157 is used to notify the CPU 172 (see FIG. 1) that the index finger 110 has returned to it default position. A wrist torsion spring 185 is used to return the right hand 108 and left hand 109 to their default positions, as more clearly seen in FIG. 1.

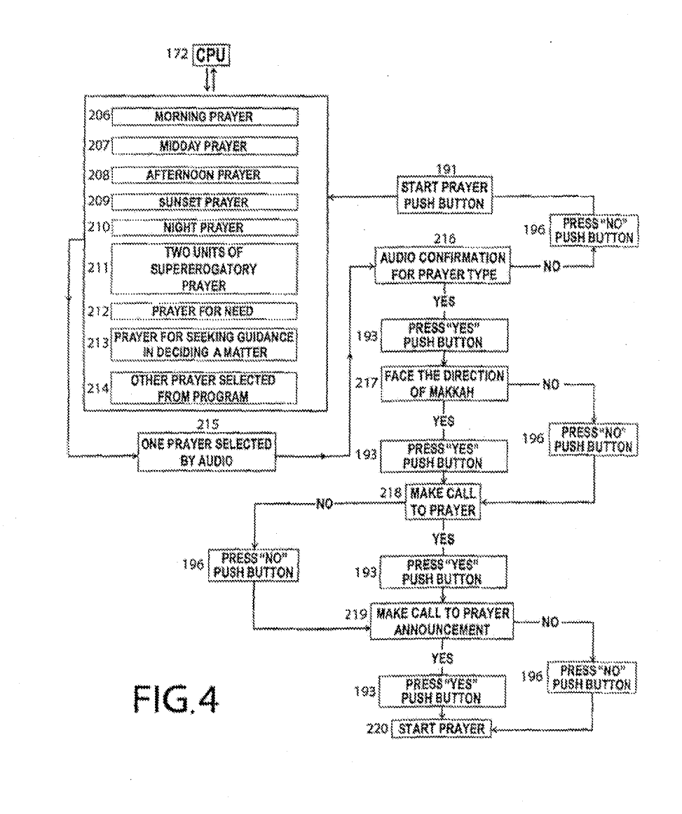

FIG. 4 is a block diagram explaining an action decision process by the CPU 172. The action decision process of the CPU 172, is done prior to the initiation of the prayer demonstration. When pressed, the start prayer push button 191 will initiate a prayer selection sequence which will cycle through the different prayer options available. Working in conjunction with the CPU 172, the first prayer option to appear will be the Fajr or Dawn to pre-sunrise prayer 206. If no further action is taken, this will cause the CPU to automatically select one prayer and to make an audio confirmation for the prayer type 216. If the prayer type announced is correct the user (not shown) will press the “YES” push button 193. If the prayer type announced is incorrect the user will press the “NO” push button 196 which will begin the selection cycle once again with the pressing of the start prayer push button 191. The prayer options are as follows, the Fajr or Dawn to pre-sunrise prayer 206, the Dhuhr or after true noon prayer 207, the Asr or afternoon prayer 208, the Maghrib or after sunset until dusk prayer 209, the Isha'a or dusk until dawn prayer 210. The CPU 172, could also be programmed to have additional prayers, such as, for example, two units of supererogatory prayer 211, the prayer for need 212, the prayer for seeking guidance in deciding a matter 213 and another prayer selected from program 214, to name a few. When the correct prayer type has been announced the user will press the “YES” push button 193 to proceed in the prayer selection sequence. After that the user will be given the option to have the instructional humanoid robot 159 face the direction of Mecca or Makkah 217. If correct, the user will press the “YES” push button 193 and the instructional humanoid robot 159, along with the base 119, will and turn to the direction of Makkah. This could be done in a number of ways, such as, for example, utilizing a GPS (Global Positioning Satellite) system to locate Makkah, and then either manually or automatically orienting the inventive instructional humanoid robot 159, to face the direction of Mecca or Makkah. However, if the user wants to skip this step they simply press the “NO” push button 196. Following this the user will be given the option for the instructional humanoid robot 159 to make the call to prayer 218. If correct, the user will press the “YES” push button 193 and the instructional humanoid robot 159 will make the call to prayer 218. If the user wants to skip this step they simply press the “NO” push button 196. The user will then be given the option for the instructional humanoid robot 159 to make the call to prayer announcement 219. If correct, the user will press the “YES” push button 193 and the instructional humanoid robot 159 will make the call to prayer announcement 219. If the user wants to skip this step they simply press the “NO” push button 196. At this point after the prayer selection and options sequence has been completed, the instructional humanoid robot 159 is ready to start prayer 220.

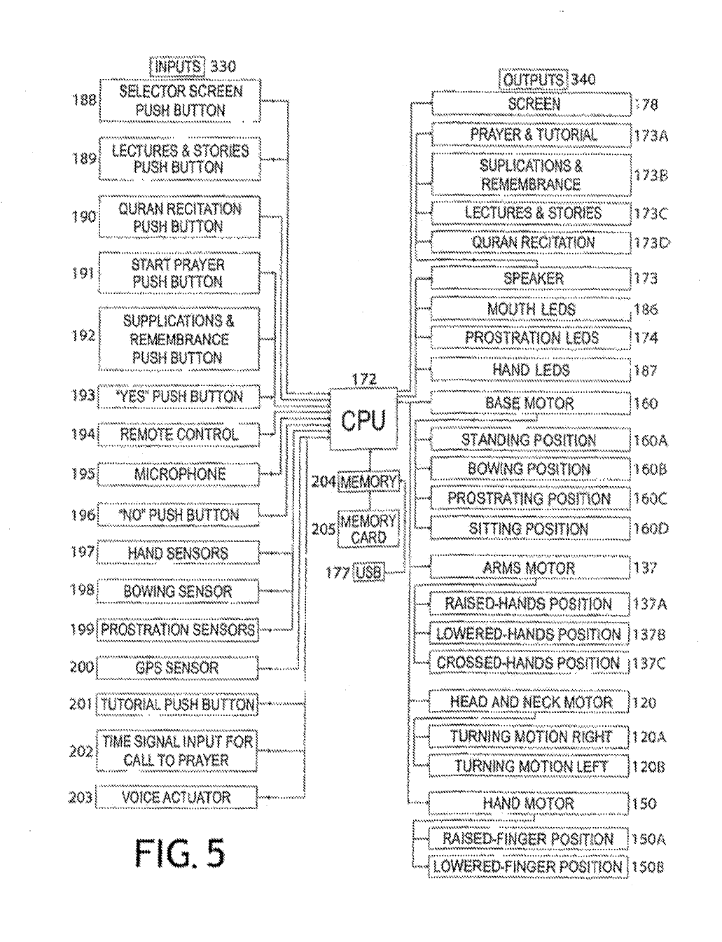

FIG. 5 is a block diagram showing the circuit configuration of the instructional humanoid robot 159, according to one embodiment of the invention. The inputs 330, from the CPU 172, could be selected from a group comprising, a selector screen push button 188, a lectures and stories push button 189, a Quran recitation push button 190, a start prayer push button 191, a supplications and remembrance push button 192, a “YES” push button 193, a remote control 194, a microphone 195, a “NO” push button 196, a hand sensors 197, a bowing sensor 198, a prostration sensors 199, a GPS sensor 200, a tutorial push button 201, a time signal input for call to prayer 202, a voice actuator 203, to name a few, are all inputs into the CPU 172. The outputs 340, for the CPU 172, could be selected from a group comprising, a device 178, such as, a screen 178, a prayers and tutorial 173A, a supplication and remembrance 173B, a lectures and stories 173C, a Quran recitation 173D, a speaker 173, a mouth LEDs 186, a prostration LEDs 174, a hand LEDs 187, a base motor 160, a standing position 160A, a bowing position 160B, a prostrating position 160C, a sitting position 160D, an arms motor 137, a raised-hands position 137A, a lowered-hands position 137B, a crossed-hands position 137C, a head and neck motor 120, a right turning motion 120A, a left turning motion 120B, a hand motor 150, a raised-index finger 110 position 150A, a lowered-index finger 110 position 150B, to name a few, which are all outputs 340, for the CPU 172. Attached to the CPU 172, is the CPU's memory 204, which can be augmented by both a memory card 205 and an electronic device 177, such as, a USB 177, for direct upload.

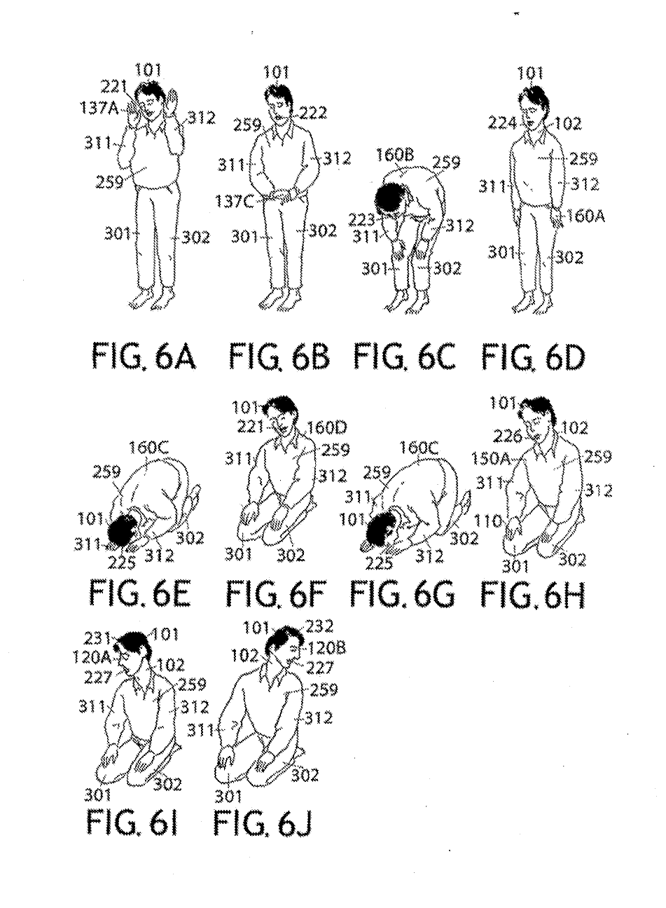

FIG. 6A is a front perspective view showing a Muslim 259, beginning the prayer in a standing position 160A, with hands raised position 137A, which the instructional humanoid robot 159, will mimic.

FIG. 6B is a front perspective view showing a Muslim 259, praying in a standing position 160A, with hands crossed 137C, over the torso 103, which the instructional humanoid robot 159, will mimic.

FIG. 6C is a front perspective view showing a Muslim 259, praying in a bowing position 160B, with hands 108, 109, placed on the right and left knee 322, respectively, which the instructional humanoid robot 159, will mimic.

FIG. 6D is a front perspective view showing a Muslim 259, praying in a standing position 160A, with hands 108, 109, resting at sides which the instructional humanoid robot 159, will mimic.

FIG. 6E is a front perspective view showing a Muslim 259, praying in a prostrating position 160C, which the instructional humanoid robot 159, will mimic.

FIG. 6F is a front perspective view showing a Muslim 259, praying in a sitting position 160D, which the instructional humanoid robot 159, will mimic.

FIG. 6G is a front perspective view showing a Muslim 259, praying in a prostrating position 160C, which the instructional humanoid robot 159, will mimic.

FIG. 6H is a front perspective view showing a Muslim 259, praying in a sitting position 160D, which the instructional humanoid robot 159, will mimic.

FIG. 6I is a front perspective view showing a Muslim 259, praying in a sitting position 160D, with the head 101, turned to the right 120A, which the instructional humanoid robot 159, will mimic.

FIG. 6J is a front perspective view showing a Muslim 259, praying in a sitting position 160D, with the head 101, turned to the left 120B, which the instructional humanoid robot 159, will mimic.

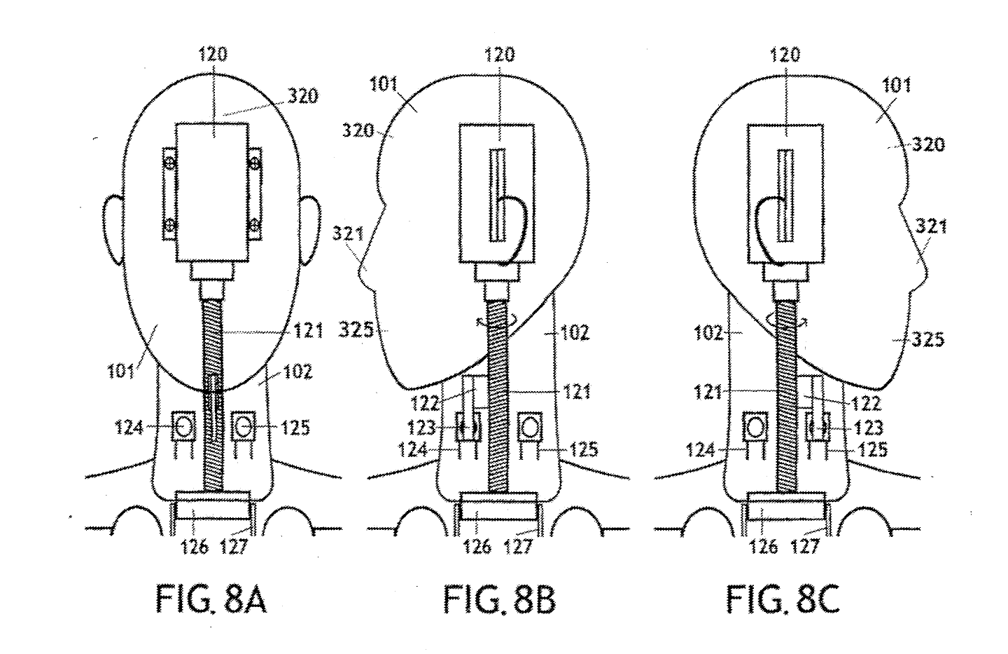

Referring now to FIGS. 6A through 6J which show the sequence of the daily Islamic prayer which the instructional humanoid robot 159 will mimic. The instructional humanoid robot 159 will begin in a standing position 160A, with hands raised position 137A, as shown in FIG. 6A. The instructional humanoid robot 159 will thereafter cross its lower right arm 106 and lower left arm 107 over the torso 103 placing the right hand 108 over the left hand 109, which is a crossed-hands position 137C, as shown in FIG. 6B. The instructional humanoid robot 159 will thereafter move into a bowing position 160B, with hands 108, 109, placed on the right and left knee 322, respectively, as shown in FIG. 6C. The instructional humanoid robot 159 will thereafter return to a standing position 160A, with arms 311, 312, resting at sides of the torso 103, and legs 301, 302, as shown in FIG. 6D. The instructional humanoid robot 159 will thereafter move down into a prostrating position 160C, placing its nose 321, forehead 320, hands 108, 109, and knees 322, on the ground 345, as shown in FIG. 6E. The instructional humanoid robot 159 will thereafter raise up into a sitting position 160D, placing the hands 108, 109, on the right and left knee 322, respectively, as shown in FIG. 6F. The instructional humanoid robot 159 will thereafter return to a prostrating position 160C, placing its nose 321, forehead 320, hands 108, 109, and knees 322, on the ground 345, as shown in FIG. 6G. The instructional humanoid robot 159 will thereafter return to a sitting position 160D, placing the hands 108, 109, on the right and left knee 322, respectively, as shown in FIG. 6H. At this point instructional humanoid robot will either return to a standing position 160A, with hands raised position 137A, as shown in FIG. 6A, or proceed to the next positions, as shown in FIGS. 6I and 6J, respectively, depending on the type of prayer that is being demonstrated. The instructional humanoid robot 159 will conclude the prayer by first turning its head 101, fully to the right position 120A, as shown in FIGS. 6I and 8B, and then fully to the left position 120 B, as shown in FIGS. 6J and 8C.

FIG. 7 is a block diagram showing an Islamic prayer sequence which the instructional humanoid robot 159, will demonstrate. Once the start prayer 220 signal has been activated the instructional humanoid robot 159 will proceed to begin demonstrating the prayer. In Step 1 of the prayer sequence, the CPU 172 will signal the arms motor 137 to activate and move the arms 311, 312, into the raised-hands position 137A, while simultaneously signaling the mouth LEDs 186 to light up and the speaker 173 to project a pre-programmed audio clip which will say “Allahu Akbar” 221. In Step 2 of the prayer sequence, the CPU 172 will signal the arms motor 137 to activate and move the arms 311, 312, into the crossed-hands position 137C, while simultaneously signaling the mouth LEDs 186 to light up and the speaker 173 to start recitation 222 of pre-programmed audio clips from the Quran stored on the memory card 205. In Step 3 of the prayer sequence, the CPU 172 will once again signal the arms motor 137 to activate and move the arms 311, 312, into the raised-hands position 137A, while simultaneously signaling the mouth LEDs 186 to light up and the speaker 173 to project a pre-programmed audio clip which will say “Allahu Akbar” 221. In Step 4 of the prayer sequence, the CPU 172 will signal the base motor 160 to activate and move the instructional humanoid robot 159 into the bowing position 160B while simultaneously signaling the mouth LEDs 186 and the hand LEDs 187 to light up and the speaker 173 to project a pre-programmed audio clip which will say “Subhana rabiya al-atheem” at least three times 223. In Step 5 of the prayer sequence, the CPU 172 will signal the base motor 160 to activate and move the instructional humanoid robot 159 back into the standing position 160A while simultaneously signaling the mouth LEDs 186 to light up and the speaker 173 to project a pre-programmed audio clip which will say “Samia Allahu liman hammidah” 224. In Step 6 of the prayer sequence, the CPU 172 will signal the arms motor 137 to activate and move the arms 311, 312, into the raised-hands position 137A, while simultaneously signaling the mouth LEDs 186 to light up and the speaker 173 to project a pre-programmed audio clip which will say “Allahu Akbar” 221. In Step 7 of the prayer sequence, the CPU 172 will signal the base motor 160 to activate and move the instructional humanoid robot 159 into the prostrating position 160C while simultaneously signaling the mouth LEDs 186 and the prostration LEDs 174 to light up and the speaker 173 to project a pre-programmed audio clip which will say “Subhana Rabiya al-Ala” at least three times 225. In Step 8 of the prayer sequence, the CPU 172 will signal the base motor 160 to activate and move the instructional humanoid robot 159 into the sitting position 160D while simultaneously signaling the mouth LEDs 186 to light up and the speaker 173 to project a pre-programmed audio clip which will say “Allahu Akbar” 221. In Step 9 of the prayer sequence, the CPU 172 will signal the base motor 160 to activate and move the instructional humanoid robot 159 back into the prostrating position 160C while simultaneously signaling the mouth LEDs 186 and the prostration LEDs 174 to light up and the speaker 173 to project a pre-programmed audio clip which will say “Subhana Rabiya al-Ala” at least three times 225. In Step 10 of the prayer sequence, the CPU 172 will signal the base motor 160 to activate and move the instructional humanoid robot 159 back into the standing position 160A while simultaneously signaling the mouth LEDs 186 to light up and the speaker 173 to project a pre-programmed audio clip which will say “Allahu Akbar” at least three times 221. Step 11 of the prayer sequence is comprised of Steps 2 to 10. In Step 12 of the prayer sequence, the CPU 172 will signal the hand motor 150 to activate and move the right index finger 110 into the raised-finger position 150A while simultaneously signaling the mouth LEDs 186 to light up and the speaker 173 to project a pre-programmed audio clip which start supplication 226. In Step 13 of the prayer sequence, the CPU 172 will signal head and neck motor 120 to activate and rotate the head 101 to turning motion right position 120A while simultaneously signaling the mouth LEDs 186 to light up and the speaker 173 to project a pre-programmed audio clip which will say “As-salaamu alaykum wa rahmatullah” 227. In Step 14 of the prayer sequence, the CPU 172 will signal head and neck motor 120 to activate and rotate the head 101 to the turning motion left position 120B while simultaneously signaling the mouth LEDs 186 to light up and the speaker 173 to project a pre-programmed audio clip which will say “As-salaamu alaykum wa rahmatullah” 227. The prayer will then end at step 230.

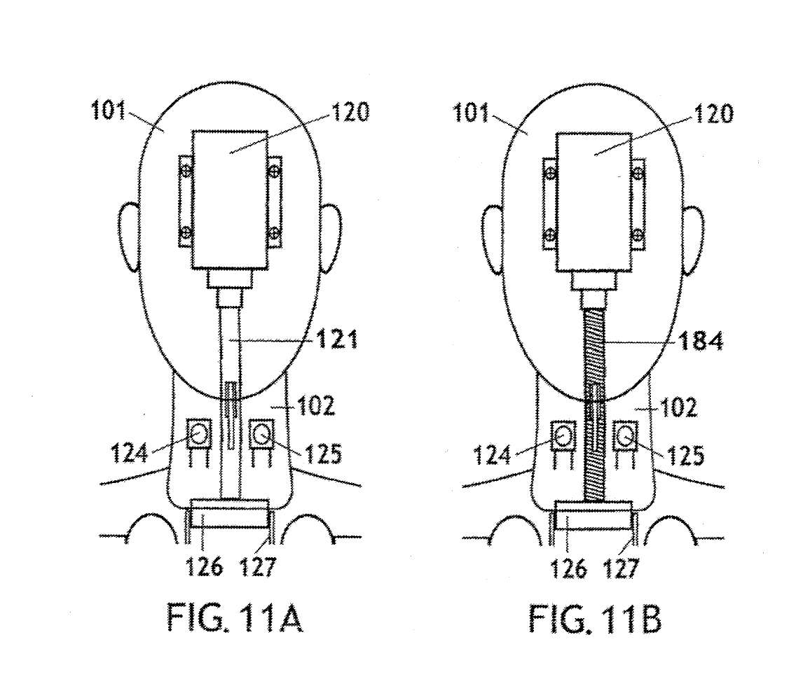

FIG. 8A is a front view of the head 101, and neck 102, of the instructional humanoid robot 159, with the head 101, facing forward, while FIG. 8B is a front view of the head 101, and neck 102, of the instructional humanoid robot 159, with the head 101, turned to the right side 231, and wherein FIG. 8C is a front view of the head 101, and neck 102, of the instructional humanoid robot 159, with the head 101, turned to the left side 232. Referring to FIGS. 8A, 8B and 8C there is shown a head 101 and neck 102 within which there is located a vertically mounted head and neck shaft motor 120 which is capable of rotating clockwise and counterclockwise. Attached to the head and neck shaft motor 120 is the head and neck shaft 121 running vertically though the head 101 and the neck 102 into the pivoting neck roller 126, to which it is affixed. In another embodiment, the head and neck shaft 121 can be replaced with a tension spring 184 as shown in FIG. 11B. Mounted to the bottom of the head 101 is a rotating plate 122 that holds the neck sensor rod 123. A right neck sensor switch 124 and a left neck sensor switch 125 are located to the right and left of the head and neck shaft 121, respectively, at the same distance as the rotating plate 122. The right neck sensor switch 124, and the left neck sensor switch 125, can work either as contact switches or non-contact switches. With the head and neck shaft 121 affixed to the pivoting neck roller 126 located at the bottom of the neck 102, any rotation of the head and neck shaft motor 120 clockwise or counter-clockwise will in turn cause the head 101 to turn right or left in relation to the neck 102. When contacted by the neck sensor rod 123 the right neck sensor switch 124 and the left neck sensor switch 125 will relay a signal to the CPU 172 (see FIG. 1) indicating that the head 101 has rotated to the right from a face forward position or to the left from a face forward position which will in-turn stop the rotation of the head and neck motor 120 as shown in FIG. 8B and FIG. 8C respectively. The pivoting neck roller 126 located at the bottom of the neck 102 to which the head and neck shaft 121 is affixed will allow the neck 102 to pivot forwards and backwards as pressure is applied to it. A neck tension spring 127 located on either side of the pivoting neck roller 126 will return the head 101 and neck 102 to their default upright face forward position.

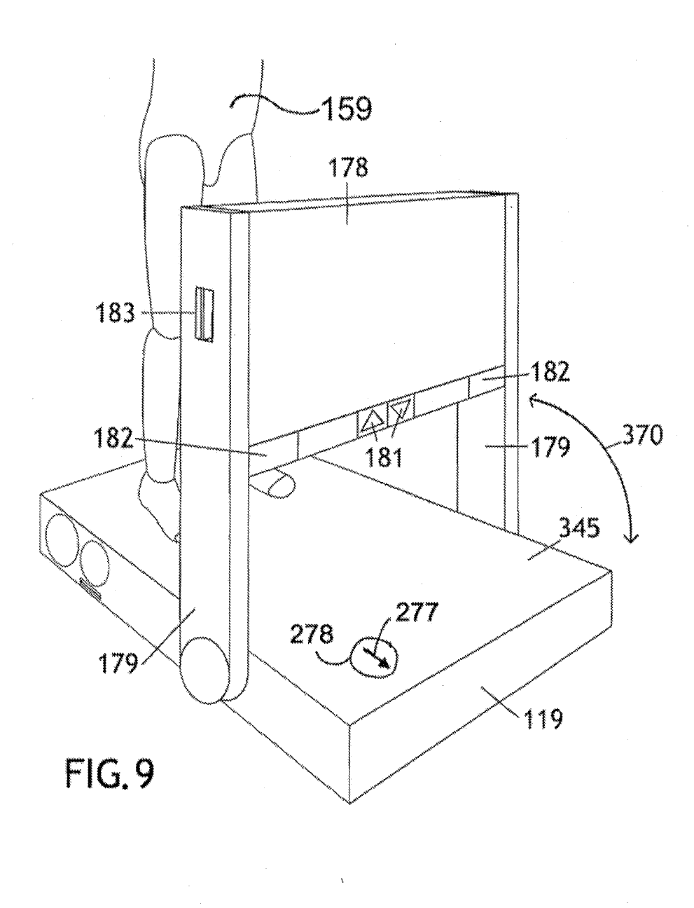

FIG. 9 is a front perspective view of the detachable and foldable screen 179, that is attached to the base 119, of the instructional humanoid robot 159. Referring to FIG. 9 there is shown a detachable and foldable screen holder 179, attached to the base 119, which holds a screen 178, that can be used in conjunction with the instructional humanoid robot 159, to help educate a user. Attached to this screen 178, are controls 181, such as, for example, audio volume controls 181, speakers 182, and at least one electronic port 183, such as, for example, a USB port 183 for transferring data to and from the screen. Data transfer cable (not shown) can run through the screen holder 179, connecting the screen 178, to the base 119, or this could be done by other means, for example, wirelessly. Optionally, the screen 178, could be pivotally and rotationally adjustable along the path 370. It should be appreciated that the screen 178 could also be used to display a compass, which could be used to point to the north, or the true north, or towards Kaba, in Makkah, Saudi Arabia, or to locate any direction desired by a user or operator. Similarly, for some applications the screen 178, could be secured to the base 119, as shown in FIG. 9, however, for some applications the screen 178, could be a stand-alone system or it could be a part of the base 119. Similarly, the screen 178 could be held vertically or it could be placed horizontally along the ground 345, or base 119, or at any angle along the path 370. Furthermore, the apparatus could also have a primary or a secondary screen 278, to display any feature that has been mentioned in this patent application, such as, for example, the direction to Kaba 277, in Makkah, Saudi Arabia. The primary or the secondary screen 278, could be analog or digital or it could be a touch sensitive screen 278, and it could be used display any feature of this invention 277, or any feature 277, to supplement this invention. The primary or a secondary screen 278, could also be used to enhance or supplement any feature that may be displayed on screen 178. It should be appreciated that both screens 178, 278, could work in harmony, and could be jointly or independently electronically connected to the computer 172, or CPU 172, or any other similar such device 172.

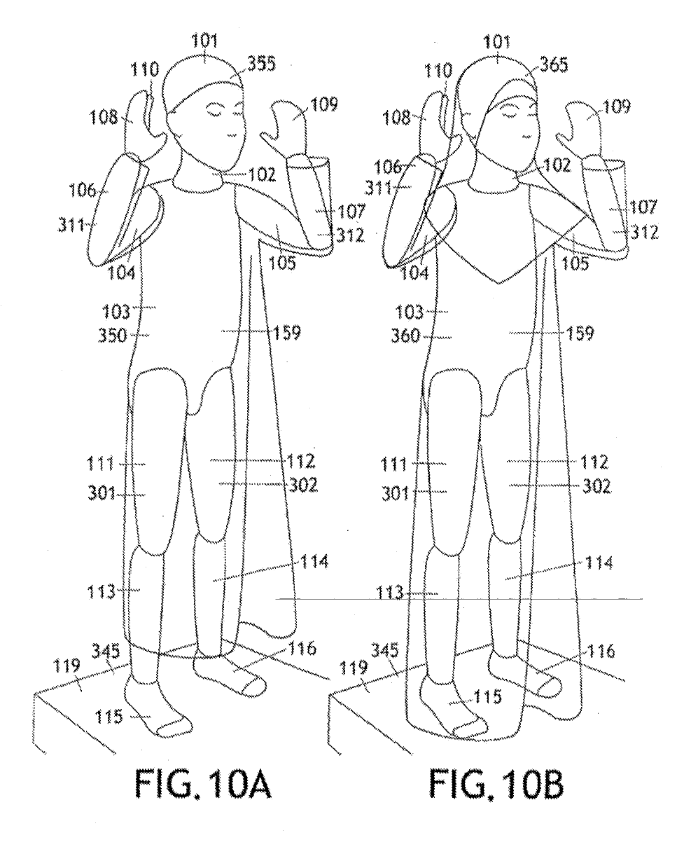

FIG. 10A is a front perspective view showing a Muslim male 259, praying in a standing position 160A, with hands raised 137A, which the instructional humanoid robot 159, will mimic, wearing a robe or a garment 350, and head covering 355, such as, a cap 355, hat 355, etc.

FIG. 10B is a front perspective view showing a Muslim female 259, praying in a standing position 160A, with hands raised 137A, which the instructional humanoid robot 159, will mimic, wearing a dress 360, and a head covering 365, such as, a hijab 365, a headscarf 365, etc.

It should be appreciated that the instructional humanoid robot 159, can be dressed in male Islamic attire or a female Islamic attire, as shown in FIGS. 10A and 10B, respectively. However, it should also be understood that the male Islamic attire and female Islamic attire can change from country to country and region to region, and thus this should not be a limiting factor.

FIG. 11A is a front view of the head 101, and neck 102, of the instructional humanoid robot 159, with the head 101, facing forward.

FIG. 11B is a front view of the head 101, and neck 102, of the instructional humanoid robot 159, with the head 101, facing forward. It should be appreciated that FIG. 11A and FIG. 11B show two different embodiments. FIG. 11A displays a head and neck shaft 121, whereas FIG. 11B, displays it replaced with a tension spring 184. Both have the same function but work in slightly different ways.

FIG. 12 is a side profile view of the instructional humanoid robot 159, in a hands-raised position 137A.

The instructional humanoid robot 159, for teaching the correct manner of performing the Islamic prayer, comprises,

means for forming the head 101, of the instructional humanoid robot 159;

means for forming the neck 102, of the instructional humanoid robot 159;

means for forming the torso 103, of the instructional humanoid robot 159;

means for forming the right upper arm 104, of the instructional humanoid robot 159;

means for forming the left upper arm 105, of the instructional humanoid robot 159;

means for forming the right lower arm 106, of the instructional humanoid robot 159;

means for forming the left lower arm 107, of the instructional humanoid robot 159;

means for forming the right hand 108, of the instructional humanoid robot 159;

means for forming the left hand 109, of the instructional humanoid robot 159;

means for forming the index finger 110, of the instructional humanoid robot 159, attached to the right hand 108;

means for forming the right upper leg 111, of the instructional humanoid robot 159;

means for forming the left upper leg 112, of the instructional humanoid robot 159;

means for forming the right lower leg 113, of the instructional humanoid robot 159;

means for forming the left lower leg 114, of the instructional humanoid robot 159;

means for forming the right foot 115, of the instructional humanoid robot 159;

means for forming the left foot 116, of the instructional humanoid robot 159;

means for forming the right toe 117, of the instructional humanoid robot 159;

means for forming the left toe 118, of the instructional humanoid robot 159;

means for forming the base 119, for the instructional humanoid robot 159;

means for rotating the head and neck shaft 121;

means for rotating the head 101, and the rotating plate 122;

means for holding the neck sensor rod 123;

means for activating the right neck sensor switch 124, and left neck sensor switch 125;

means for relaying an electronic signal to the CPU 172, when contacted by the neck sensor rod 123, indicating that the head and neck shaft 121 has rotated approximately or about ninety degrees to the right;

means for relaying an electronic signal to the CPU 172, when contacted by the neck sensor rod 123, indicating that the head and neck shaft 121 has rotated approximately or about one hundred and eighty degrees to the left;

means for allowing the head 101, and neck 102, to pivot backwards when the head 101 comes in contact with the base 119;

means for pushing the head 101, and neck 102, back into an upright default position;

means for working in conjunction with the shoulder joint 129, to form a pivoting point for the shoulder rod 130;

means for working in conjunction with the pivoting ball 128, to form a pivoting point for the shoulder rod 130;

means for pivoting between the shoulder joint 129, and the pivoting ball 128, to raise or lower the arm 311, 312;

means for rotating the shoulder rod 130, up and down depending on the position of the master moving collet 140;

means for controlling the rotation of the shoulder bracket 131;

means for holding the upper arm bracket 134;

means for connecting the upper arm 104, 105, to the torso tension elastic 135;

means for controlling the movement of the upper arm 104, 105;

means for guiding the torso tension elastic 135;

means for rotating the threaded torso shaft 138 clockwise or counter-clockwise;

means for moving the threaded collet 158 up or down depending on the rotation of the arms motor 137;

means for controlling the movement of the master moving collet 140 up and down the threaded torso shaft 138;

means for forming a compression barrier between the threaded collet 138 and the master moving collet 140;

means for controlling the movement of the upper and lower arms 104, 105, 106 and 107;

means for forming a compression barrier between the master moving collet 140 and the end of the threaded torso shaft 138;

means for returning the upper and lower arms 104, 105, 106 and 107 to their default position;

means for holding the upper, middle and lower sensor rollers 144, 145 and 146;

means for activating the upper and lower sensor switches 147 and 148 when contacted;

means for activating the upper sensor switch 147 when contacted;

means for relaying an electronic signal to the CPU 172 when contacted by the upper, lower and/or middle sensor rollers 144, 145 and 146 indicating that the arms 104, 105, 106 and 107 and hands 108 and 109 are either raised up to head level 137A, crossed over the chest 137C, or hanging freely at the sides 160A;

means for allowing the lower arm motor to pivot approximately or about fifteen degrees in order to maintain proper alignment with the right hand 108 to minimize overall tension;

means for rotating the threaded arm shaft 151 clockwise and counter-clockwise;

means for moving the threaded cable holder 152 up or down depending on the rotation of the lower arm motor 150;

means for holding the finger cable 153;

means for moving the finger controller rod 155;

means for guiding the finger cable 154;

means for moving the right index finger 110 up and down;

means for returning the index finger 110 to its default position;

means for relaying an electronic signal to the CPU 172 when it comes in contact with the top of the right upper leg 111 indicating that the instructional humanoid robot 159 is in a sitting position 160D;

means for returning the hand 108 and 109 to its default position;

means for pulling or pushing the torque cable 161;

means for controlling the movement of the torso 103;

means for guiding the torque cable 162 and 163;

means for pivoting the back support board 165;

means for pivoting and providing structural support for the torso 103;

means for returning the back support board 165 to its default position and regulating the rate of its rotation;

means for returning the back support board 165 to its default position;

means for returning the upper legs 111 and 112 to their default position and regulating the rate of their rotation;

means for returning the lower legs 113 and 114 to their default position and regulating the rate of their rotation;

means for returning the feet 115 and 116 to their default position and regulating the rate of their rotation;

means for returning the toe 117 and 118 to its default position;

means for running and controlling all the functions of the instructional humanoid robot 159;

means for projecting pre-recorded audio;

means for emitting light;

means for regulating the rate at which the feet 115 and 116 pivots with the toes 117 and 118;

means for recording audio to be played back through the speakers 173; and

means for transferring data to the CPU 172.

The instructional humanoid robot 159, further comprises:

a head 101;

a neck 102;

comprises a torso 103;

a right upper arm 104;

a left upper arm 105;

a right lower arm 106;

a left lower arm 107;

a right hand 108;

a left hand 109.

The instructional humanoid robot 159, further comprises:

wherein said means for forming the index finger 110 of the instructional humanoid robot 159 attached to the right hand 108 comprises an index finger 110;

wherein said means for forming the right upper leg 111 of the instructional humanoid robot 159 comprises a right upper leg 111;

wherein said means for forming the left upper leg 112 of the instructional humanoid robot 159 comprises a left upper leg 112;

wherein said means for forming the right lower leg 113 of the instructional humanoid robot 159 comprises a right lower leg 113;

wherein said means for forming the left lower leg 114 of the instructional humanoid robot 159 comprises a left lower leg 114;

wherein said means for forming the right foot 115 of the instructional humanoid robot 159 comprises a right foot 115;

wherein said means for forming the left foot 116 of the instructional humanoid robot 159 comprises a left foot 116;

wherein said means for forming the right toe 117 of the instructional humanoid robot 159 comprises a right toe 117;

wherein said means for forming the left toe 118 of the instructional humanoid robot 159 comprises a left toe 118;

wherein said means for forming the base 119 for the instructional humanoid robot 159 comprises a base 119;

wherein said means for rotating the head and neck shaft 121 comprises a head and neck shaft motor 120;

wherein said means for rotating the head 101 and the rotating plate 122 comprises a head and neck shaft 121.

The instructional humanoid robot 159, further comprises:

wherein said means for holding the neck sensor rod 123 comprises a rotating plate 122;

wherein said means for activating the right and left neck sensor switches 124 and 125 comprises a neck sensor rod 123;

wherein said means for relaying an electronic signal to the CPU 172 when contacted by the neck sensor rod 123 indicating that the head and neck shaft 121 has rotated approximately or about ninety degrees to the right comprises a right neck sensor switch 124;

wherein said means for relaying an electronic signal to the CPU 172 when contacted by the neck sensor rod 123 indicating that the head and neck shaft 121 has rotated approximately or about one hundred and eighty degrees to the left comprises a left neck sensor switch 125.

The instructional humanoid robot 159, further comprises:

wherein said means for allowing the head 101 and neck 102 to pivot backwards when the head 101 comes in contact with the base 119 comprises a pivoting neck roller 126;

wherein said means for pushing the head 101 and neck 102 back into an upright default position comprises a neck tension spring 127;

wherein said means for working in conjunction with the shoulder joint 129 to form a pivoting point for the shoulder rod 130 comprises a pivoting ball 128;

wherein said means for working in conjunction with the pivoting ball 128 to form a pivoting point for the shoulder rod 130 comprises a shoulder joint 129;

wherein said means for pivoting between the shoulder joint 129 and the pivoting ball to raise or lower the arm 104, 105, 106 and 107 comprises a shoulder rod 130;

wherein said means for rotating the shoulder rod 130 up and down depending on the position of the master moving collet 140 comprises a shoulder bracket 131;

wherein said means for controlling the rotation of the shoulder bracket 131 comprises a shoulder controller rod 132;

wherein said means for holding the upper arm bracket 134 comprises an upper arm rod 133;

wherein said means for connecting the upper arm rod 133 to the torso tension elastic 135 comprises an upper arm bracket 134;

wherein said means for controlling the movement of the upper arm rod 133 comprises a torso tension elastic 135;

wherein said means for guiding the torso tension elastic 135 comprises a tension elastic roller 136;

wherein said means for rotating the threaded torso shaft 138 clockwise or counter-clockwise comprises an arms motor 137;

wherein said means for moving the threaded collet 158 up or down depending on the rotation of the arms motor 137 comprises a threaded torso shaft 138;

wherein said means for controlling the movement of the master moving collet 140 up and down the threaded torso shaft 138 comprises a threaded collet 158;

wherein said means for forming a compression barrier between the threaded collet 158 and the master moving collet 140 comprises a lower compression spring 139;

wherein said means for controlling the movement of the 104, 105, 106 and 107 right and left arms comprises a master moving collet 140;

wherein said means for forming a compression barrier between the master moving collet 140 and the end of the threaded torso shaft 138 comprises an upper compression spring 141;

wherein said means for returning the upper and lower arms 104, 105, 106 and 107 to their default position comprises an elbow torsion spring 142;

wherein said means for holding the upper, middle and lower sensor rollers 144, 145 and 146 comprises an arms controller sensor rod 143;

wherein said means for activating the upper and lower sensor switches 147 and 148 when contacted comprises an upper sensor roller 144;

wherein said means for activating the upper sensor switch 147 when contacted comprises a middle sensor roller 145;

wherein said means for activating the upper and lower sensor switches 147 and 148 when contacted comprises a lower sensor roller 146;

wherein said means for relaying an electronic signal to the CPU 172 when contacted by the upper, lower and/or middle sensor rollers 144, 145 and 146 indicating that the arms 104, 105, 106 and 107 and hands 108 and 109 are either raised up to head level 137A, crossed over the chest 137C, or hanging freely at the sides 160A comprises an upper sensor switch 147;

wherein said means for relaying an electronic signal to the CPU 172 when contacted by the upper, lower and/or middle sensor rollers 144, 145, 146 indicating that the arms 104, 105, 106 and 107 and hands 108 and 109 are either raised up to head level 137A, crossed over the chest 137C, or hanging freely at the sides 160A comprises a lower sensor switch 148;

wherein said means for allowing the lower arm motor 150 to pivot approximately or about fifteen degrees in order to maintain proper alignment with the right hand 108 to minimize overall tension comprises a lower arm motor pivoting point 149;

wherein said means for rotating the threaded arm shaft 151 clockwise and counter-clockwise comprises a lower arm motor 150;

wherein said means for moving the threaded cable holder 152 up or down depending on the rotation of the lower arm motor 150 comprises a threaded arm shaft 151;

wherein said means for holding the finger cable 153 comprises a threaded cable holder 152.

The instructional humanoid robot 159, further comprises:

wherein said means for moving the right index finger up and down comprises a finger cable 153;

wherein said means for guiding the finger cable 153 comprises a fixed finger cable roller 154;

wherein said means for moving the index finger 110 comprises a finger controller rod 155;

wherein said means for returning the index finger 110 to its default position comprises an index finger torsion spring 156.

The instructional humanoid robot 159, further comprises:

wherein said means for relaying an electronic signal to the CPU 172 when it comes in contact with the top of the right upper leg 111 indicating that the instructional humanoid robot 159 is in a sitting position 160D comprises a magnetic sensor switch 157;

wherein said means for returning the hand 108 and 109 to its default position comprises a wrist torsion spring 185;

wherein said means for pulling or pushing the torque cable 161 comprises a base motor 160;

wherein said means for controlling the movement of the torso 103 comprises a torque cable 161;

wherein said means for guiding the torque cable 161 comprises a fixed pin guides 162;

wherein said means for guiding the torque cable 161 comprises a fixed rollers 163;

wherein said means for pivoting the back support board 165 comprises a torso pivoting bar 164;

wherein said means for pivoting and providing structural support for the torso 103 comprises a back support board 165;

wherein said means for returning the back support board 165 to its default position and regulating the rate of its rotation comprises a back support board torsion spring 166;

wherein said means for returning the back support board to its default position comprises a back support board tension elastic 167;

wherein said means for returning the upper legs 111 and 112 to their default position and regulating the rate of their rotation comprises a hip torsion spring 168;

wherein said means for returning the lower legs 113 and 114 to their default position and regulating the rate of their rotation comprises a knee torsion spring 169;

wherein said means for returning the feet 115 and 116 to their default position and regulating the rate of their rotation comprises an ankle torsion spring 170;

wherein said means for returning the toes 117 and 118 to their default position comprises a toe tension spring 171.

The instructional humanoid robot 159, further comprises:

wherein said means for running and controlling all the functions of the instructional humanoid robot comprises a CPU 172;

wherein said means for projecting pre-recorded audio comprises a speakers 173;

wherein said means for emitting light comprises an LED lights 174;

wherein said means for regulating the rate at which the feet pivots with the toes comprises a toe torsion spring 175;

wherein said means for recording audio to be played back through the speakers 173 comprises a microphone 176;

wherein said means for transferring data to the CPU 172 comprises an USB input 177.

An instructional humanoid robot 159 for teaching the correct manner of performing the Islamic prayer, comprising:

a head 101, for forming the head of the instructional humanoid robot 159;

a neck 102, for forming the neck of the instructional humanoid robot 159;

a torso 103, for forming the torso of the instructional humanoid robot 159;

a right upper arm 104, for forming the right upper arm of the instructional humanoid robot 159;

a left upper arm 105, for forming the left upper arm of the instructional humanoid robot 159;

a right lower arm 106, for forming the right lower arm of the instructional humanoid robot 159;

a left lower arm 107, for forming the left lower arm of the instructional humanoid robot 159;

a right hand 108, for forming the right hand of the instructional humanoid robot 159;

a left hand 109, for forming the left hand of the instructional humanoid robot 159;

an index finger 110, for forming the index finger of the instructional humanoid robot 159 attached to the right hand 108;

a right upper leg 111, for forming the right upper leg of the instructional humanoid robot 159;

a left upper leg 112, for forming the left upper leg of the instructional humanoid robot 159;

a right lower leg 113, for forming the right lower leg of the instructional humanoid robot 159;

a left lower leg 114, for forming the left lower leg of the instructional humanoid robot 159;

a right foot 115, for forming the right foot of the instructional humanoid robot 159;

a left foot 116, for forming the left foot of the instructional humanoid robot 159;

a right toe 117, for forming the right toe of the instructional humanoid robot 159;

a left toe 118, for forming the left toe of the instructional humanoid robot 159;

a base 119, for forming the base for the instructional humanoid robot 159;

a head and neck shaft motor 120, for rotating the head and neck shaft 121;

a head and neck shaft 121, for rotating the head and the rotating plate;

a rotating plate 122, for holding the neck sensor rod 123;

a neck sensor rod 123, for activating the right and left neck sensor switches 124 and 125;

a right neck sensor switch 124, for relaying an electronic signal to the CPU 172 when contacted by the neck sensor rod 123 indicating that the head and neck shaft 121 has rotated approximately or about ninety degrees to the right;

a left neck sensor switch 125, for relaying an electronic signal to the CPU 172 when contacted by the neck sensor rod 123 indicating that the head and neck shaft 121 has rotated approximately or about one hundred and eighty degrees to the left;

a pivoting neck roller 126, for allowing the head 101 and neck 102 to pivot backwards when the head 101 portion comes in contact with the base 119;

a neck tension spring 117, for pushing the head 101 and neck 102 back into an upright default position;

a pivoting ball 128, for working in conjunction with the shoulder joint 129 to form a pivoting point for the shoulder rod 130;

a shoulder joint 129, for working in conjunction with the pivoting ball 128 to form a pivoting point for the shoulder rod 130;

a shoulder rod 130, for pivoting between the shoulder joint 129 and the pivoting ball 128 to raise or lower the arm 104, 105, 106 and 107;

a shoulder bracket 131, for rotating the shoulder rod 132 up and down depending on the position of the master moving collet 140;

a shoulder controller rod 132, for controlling the rotation of the shoulder bracket 131;

an upper arm rod 133, for holding the upper arm bracket 134;

an upper arm bracket 134, for connecting the upper arm rod 133 to the torso tension elastic 135;

a torso tension elastic 135, for controlling the movement of the upper arm 104 and 105;

a tension elastic roller 136, for guiding the torso tension elastic 135;

an arms motor 137, for rotating the threaded torso shaft 138 clockwise or counter-clockwise;

a threaded torso shaft 138, for moving the threaded collet 158 up or down depending on the rotation of the arms motor 137;

a threaded collet 158, for controlling the movement of the master moving collet 140 up and down the threaded torso shaft 138;

a lower compression spring 139, for forming a compression barrier between the threaded collet 158 and the master moving collet 140;

a master moving collet 140, for controlling the movement of the right and left arms 104, 105, 106 and 107;

an upper compression spring 141, for forming a compression barrier between the master moving collet 140 and the end of the threaded torso shaft 138;

an elbow torsion spring 142, for returning the upper and lower arms 104, 105, 106 and 107 to their default position;

an arms controller sensor rod 143, for holding the upper, middle and lower sensor rollers 144, 145 and 146;

an upper sensor roller 144, for activating the upper and lower sensor switches 147 and 148 when contacted;

a middle sensor roller 145, for activating the upper sensor switch 147 when contacted;

a lower sensor roller 146, for activating the upper and lower sensor switches 147 and 148 when contacted;

an upper sensor switch 147, for relaying an electronic signal to the CPU 172 when contacted by the upper, lower and/or middle sensor rollers 144, 145 and 146 indicating that the arms 104, 105, 106 and 107 and hands 108 and 109 are either raised up to head level 137A, crossed over the chest 137C, or hanging freely at the sides 160A;

a lower sensor switch 148, for relaying an electronic signal to the CPU 172 when contacted by the upper, lower and/or middle sensor rollers 144, 145 and 146 indicating that the arms 104, 105, 106 and 107 and hands 108 and 109 are either raised up to head level 137A, crossed over the chest 137C, or hanging freely at the sides 160A;

a lower arm motor pivoting point 149, for allowing the motor to pivot approximately or about fifteen degrees in order to maintain proper alignment with the right hand 108 to minimize overall tension;

a lower arm motor 150, for rotating the threaded arm shaft 151 clockwise and counter-clockwise;

a threaded arm shaft 151, for moving the threaded cable holder 152 up or down depending on the rotation of the lower arm motor 150;

a threaded cable holder 152, for holding the finger cable 153;

a finger cable 153, for moving the finger controller rod 155;

a fixed finger cable roller 154, for guiding the finger cable 153;

a finger controller rod 155, for moving right index finger 110 up and down;

an index finger torsion spring 156, for returning the index finger 110 to its default position;

a magnetic sensor switch 157, for relaying an electronic signal to the CPU 172 when it comes in contact with the top of the right upper leg 111 indicating that the instructional humanoid robot 159 is in a sitting position 160D;

a wrist torsion spring 185, for returning the hand 108 and 109 to its default position;

a base motor 160, for pulling or pushing the torque cable 161;

a torque cable 161, for controlling the movement of the torso 103;

a fixed pin guides 162, for guiding the torque cable 161;

a fixed rollers 163, for guiding the torque cable 161;

a torso pivoting bar 164, for pivoting the back support board 165;

a back support board 165, for pivoting and providing structural support for the torso 103;

a back support board torsion spring 166, for returning the back support board 165 to its default position and regulating the rate of its rotation;

a back support board tension elastic 167, for returning the back support board 165 to its default position;

a hip torsion spring 168, for returning the upper legs 111 and 112 to their default position and regulating the rate of their rotation;

a knee torsion spring 169, for returning the lower legs 113 and 114 to their default position and regulating the rate of their rotation;

an ankle torsion spring 170, for returning the feet 115 and 116 to their default position and regulating the rate of their rotation;

a toe tension spring 171, for returning the toe 117 and 118 to its default position;

a CPU 172, for running and controlling all the functions of the instructional humanoid robot 159;

a speakers 173, for projecting pre-recorded audio;

an LED lights 174, for emitting light;

a toe torsion spring 175, for regulating the rate at which the feet pivots with the toes 117 and 118;

a microphone 176, for recording audio to be played back through the speakers 173;

and

a USB input 177, for transferring data to the CPU 172.

The instructional humanoid robot 159 for teaching the correct manner of performing the Islamic prayer, further comprises:

a head 101, for forming the head of the instructional humanoid robot 159;

a neck 102, for forming the neck of the instructional humanoid robot 159;

a torso 103, for forming the torso of the instructional humanoid robot 159;

a right upper arm 104, for forming the right upper arm of the instructional humanoid robot 159;

a left upper arm 105, for forming the left upper arm of the instructional humanoid robot 159;

a right lower arm 106, for forming the right lower arm of the instructional humanoid robot 159;

a left lower arm 107, for forming the left lower arm of the instructional humanoid robot 159;

a right hand 108, for forming the right hand of the instructional humanoid robot 159;

a left hand 109, for forming the left hand of the instructional humanoid robot 159;

an index finger 110, for forming the index finger of the instructional humanoid robot 159 attached to the right hand 108;

a right upper leg 111, for forming the right upper leg of the instructional humanoid robot 159;

a left upper leg 112, for forming the left upper leg of the instructional humanoid robot 159;

a right lower leg 113, for forming the right lower leg of the instructional humanoid robot 159;

a left lower leg 114, for forming the left lower leg of the instructional humanoid robot 159;

a right foot 115, for forming the right foot of the instructional humanoid robot 159;

a left foot 116, for forming the left foot of the instructional humanoid robot 159;

a right toe 117, for forming the right toe of the instructional humanoid robot 159;

a left toe 118, for forming the left toe of the instructional humanoid robot;

a base 119, for forming the base for the instructional humanoid robot;

a head and neck shaft motor 120, for rotating the head and neck shaft 121;

a head and neck shaft 121, for rotating the head 101 and the rotating plate 122;

a rotating plate 122, for holding the neck sensor rod 123;

a neck sensor rod 123, for activating the right and left neck sensor switches 124 and 125;

a right neck sensor switch 124, for relaying an electronic signal to the CPU 172 when contacted by the neck sensor rod 123 indicating that the head and neck shaft 121 has rotated approximately or about ninety degrees to the left;

a left neck sensor switch 125, for relaying an electronic signal to the CPU 172 when contacted by the neck sensor rod 123 indicating that the head and neck shaft 121 has rotated approximately or about one hundred and eighty degrees to the left;

a pivoting neck roller 126, for allowing the head 101 and neck 102 to pivot backwards when the head 101 comes in contact with the base 119;

a neck tension spring 127, for pushing the head 101 and neck 102 back into an upright default position;

a pivoting ball 128, for working in conjunction with the shoulder joint 129 to form a pivoting point for the shoulder rod 130;

a shoulder joint 129, for working in conjunction with the pivoting ball 128 to form a pivoting point for the shoulder rod 130;

a shoulder rod 130, for pivoting between the shoulder joint 129 and the pivoting ball 128 to raise or lower the arm 104, 105, 106 and 107;

a shoulder bracket 131, for rotating the shoulder rod 132 up and down depending on the position of the master moving collet 140;

a shoulder controller rod 132, for controlling the rotation of the shoulder bracket 131;

an upper arm rod 133, for holding the upper arm bracket 134;

an upper arm bracket 134, for connecting the upper arm rod 133 to the torso tension elastic 135;

a torso tension elastic 135, for controlling the movement of the upper arm 104 and 105;

a tension elastic roller 136, for guiding the torso tension elastic 135;

an arms motor 137, for rotating the threaded torso shaft 138 clockwise or counter-clockwise;

a threaded torso shaft 138, for moving the threaded collet 158 up or down depending on the rotation of the arms motor 137;

a threaded collet 158, for controlling the movement of the master moving collet 140 up and down the threaded torso shaft 138;

a lower compression spring 139, for forming a compression barrier between the threaded collet 158 and the master moving collet 140;

a master moving collet 140, for controlling the movement of the right and left arms 104, 105, 106 and 107;

an upper compression spring 141, for forming a compression barrier between the master moving collet 140 and the end of the threaded torso shaft 138;

an elbow torsion spring 142, for returning the upper and lower arms 104, 105, 106 and 107 to their default position.

The instructional humanoid robot 159 for teaching the correct manner of performing the Islamic prayer, further comprises:

an arms controller sensor rod 143, for holding the upper, middle and lower sensor rollers 144, 145 and 146;

an upper sensor roller 144, for activating the upper and lower sensor switches 147 and 148 when contacted;

a middle sensor roller 145, for activating the upper sensor switch 147 when contacted;

a lower sensor roller 146, for activating the upper and lower sensor switches 147 and 148 when contacted;

an upper sensor switch 147, for relaying an electronic signal to the CPU 172 when contacted by the upper, lower and/or middle sensor rollers 144, 145 and 146 indicating that the arms 104, 105, 106 and 107 and hands 108 and 109 are either raised up to head level 137A, crossed over the chest 137C, or hanging freely at the sides 160A;

a lower sensor switch 148, for relaying an electronic signal to the CPU 172 when contacted by the upper, lower and/or middle sensor rollers 144, 145 and 146 indicating that the arms 104, 105, 106 and 107 and hands 108 and 109 are either raised up to head level 137A, crossed over the chest 137C, or hanging freely at the sides 160A.

The instructional humanoid robot 159 for teaching the correct manner of performing the Islamic prayer, further comprises:

a lower arm motor pivoting point 149, for allowing the motor to pivot approximately or about fifteen degrees in order to maintain proper alignment with the right hand 108 to minimize overall tension;

a lower arm motor 150, for rotating the threaded arm shaft 151 clockwise and counter-clockwise;

a threaded arm shaft 151, for moving the threaded cable holder 152 up or down depending on the rotation of the lower arm motor 150;

a threaded cable holder 152, for holding the finger cable 153;

a finger cable 153, for moving the finger controller rod 155;

a fixed finger cable roller 154, for guiding the finger cable 153;

a finger controller rod 155, for moving right index finger 110 up and down;

an index finger torsion spring 156, for returning the index finger 110 to its default position.

The instructional humanoid robot 159 for teaching the correct manner of performing the Islamic prayer, further comprises:

a magnetic sensor switch 157, for relaying an electronic signal to the CPU 172 when it comes in contact with the top of the right upper leg 111 indicating that the instructional humanoid robot 159 is in a sitting position 160D;

a wrist torsion spring 185, for returning the hand 108 and 109 to its default position;

a base motor 160, for pulling or pushing the torque cable 161;

a torque cable 161, for controlling the movement of the torso 103;

a fixed pin guides 162, for guiding the torque cable 161;

a fixed rollers 163, for guiding the torque cable 161;

a torso pivoting bar 164, for pivoting the back support board 165;

a back support board 165, for pivoting and providing structural support for the torso 103;

a back support board torsion spring 166, for returning the back support board 165 to its default position and regulating the rate of its rotation;

a back support board tension elastic 167, for returning the back support board 165 to its default position;

a hip torsion spring 168, for returning the upper legs 111 and 112 to their default position and regulating the rate of their rotation;

a knee torsion spring 169, for returning the lower legs 113 and 114 to their default position and regulating the rate of their rotation;

an ankle torsion spring 170, for returning the feet 115 and 116 to their default position and regulating the rate of their rotation;

a toe tension spring 171, for returning the toe 117 and 118 to its default position.

The instructional humanoid robot 159 for teaching the correct manner of performing the Islamic prayer, further comprises:

a CPU 172, for running and controlling a the functions of the instructional humanoid robot 159;

a speakers 173, for projecting pre-recorded audio;

an LED lights 174, for emitting light;

a toe torsion spring 175, for regulating the rate at which the ft pivots with the toes;

a microphone 176, for recording audio to be played back through the speakers 173;

and

an USB input 177, for transfixing data to the CPU 172.

The instructional humanoid robot 159 for teaching the correct manner of performing the Salah or Salat or the daily Islamic ritual prayer, and sequentially:

will automatically orient itself towards Qiblah (Direction of the Kaba) in Makkah or Mecca, Saudi Arabia, using electronic means as discussed earlier;

will stand upright with face pointed toward the spot where it will make its Sajdah (prostration);

will raise hands 108, 109, up to its ears in a way that palms either face Qiblah or face ears and will say “Allahu-Akbar,” meaning “God is the Greatest” to begin first Rakaa (unit) of prayer, as more clearly shown in FIG. 6A;

will place the right hand 108 over the left hand 109 over the lower part of the chest or stomach area, as shown in FIG. 6B; however, for female humanoid robot 159, the right hand 108 over the left hand 109, would be placed over the upper chest or bosom area;

will first recite a Du'a (Supplication); then Surah al-Fatihah or the First chapter of Holy Quran, then some other Surah(s) (Chapter(s)) or Ayaat (Verses);

will say “Allahu-Akbar” and perform Ruku' (Bowing position) by bending the upper part of the body up to a point where the neck and back are level, perpendicular to the ground, as shown in FIG. 6C;

will place both hands on the knees, as shown in FIG. 6C;

will stay in Ruku' (Bowing position), at least for a time during which “Subhan Rabbiyal Atheem,” meaning “Glory be to my Lord, the Most Great” can be said three times; will rise from bowing saying sami'a-llahuliman hamidah, meaning “God hears those who give thanks to Him” adding immediately thereafter “Rabbana laka-lhamd,” meaning “Grateful praise to You, our Lord!” as shown in FIG. 6C;

will say “Allahu-Akbar” and go down in Sajdah (prostration) by resting knees on the floor 119, placing hands first, then the tip of the nose, then the forehead on the ground 119, as shown in FIG. 6E;

while in Sajdah, elbows should stay raised off the floor 119 or on the floor 119 and both arms should stay apart from sides; the stomach and the thighs should stay apart. During the entire Sajdah, the tip of the nose and the forehead should continue to rest on the floor 119, as shown in FIG. 6E or FIG. 6G;

will stay in Sajdah at least for a time during which “Saubhan Rabbiyal Aaala,” meaning “Glory be to my Lord, the Most High” could be said three times with face pointed toward the spot where Sajdah was performed, as shown in FIG. 6E or FIG. 6G;

will rise from the first Sajdah, sit up straight, will place the left foot flat on the ground 119, under the left buttock, keeping the right foot positioned vertically, perpendicular to the ground 119, with the right toes pointed towards the Qiblah, as shown in FIG. 6F or FIG. 6H;

will rise from the second Sajdah, by first raising the forehead off the floor, then the nose-tip, then the hands, and then the knees, as shown in FIG. 6B;

will repeat the rakaa two, three or four times depending on the prayer being performed;

at the end of the second rakaa and the last rakaa of the prayer, it will once again place the left foot flat on the ground under the left buttock, keeping the right foot positioned vertically, perpendicular to the ground with the right toes pointed towards the Qiblah, as shown in FIG. 6H;

with hands resting on thighs, it will raise the right index finger in a and point towards the Qiblah until the end of the Salah for Tashahud, as shown in FIG. 6H;

to end the prayer it will give Salam (Salutation of Peace), by saying “As-Salaamu Alaykum wa Rahmatullah,” meaning “Peace be upon you and the Mercy of God,” while turning the head and neck approximately or about 90 degrees to the right, and then repeat the Salam, turning approximately or about 90 degrees to the left from the center position, as shown in FIG. 6I or FIG. 6J.

The instructional humanoid robot 159 for teaching the correct manner of performing the adhan or Azan—call to prayer for:

for the Sunni Athan and the Shi'a Athan;

Du'a (supplication) after Adhan and Salah;

Iqama (A shorter “call to prayer” that is made immediately prior to each of the five daily Islamic prayers, to let people know that the prayer is about to begin).

The instructional humanoid robot 159 for teaching the correct manner of making Du'a (Supplications), recite Holy Quran in different styles, with and without translations.

The instructional humanoid robot 159 to give Islamic lectures, teachings and Islamic stories Friday sermons with body motions and/or a monitor/screen that can be attached to the base.

The instructional humanoid robot 159 for teaching the correct Salaah and other Islamic rituals in different languages to young boys and girls of all ethnicities and new converts or reverts wearing full sunnah clothes and regular standard (western) clothes.

The instructional humanoid 159 which can work by Manual push buttons, Wireless remote control and Voice Activated mechanism.

The instructional humanoid 159 which can work as a Salah reminder time-clock at assigned times.

The instructional humanoid 159 which can record audio recitations of the Qur'an and compare it to pre-recorded recitations of the Qur'an using a built in synthesizer and thereafter correct mistakes that are made during recitation.

The instructional robot 159 having a screen 178 situated on the base 119 on which an instruction is executed by recognizing the coordinates of a selected item or a voice of a user when one of a plurality of items displayed on a touch screen is selected, the method comprising the steps of:

(a) recognizing an instruction corresponding to the coordinates of a selected item when one of items is selected on the touch screen;

(b) executing the recognized instruction if the recognized instruction is not determined to have any sub-instruction associated therewith;

(c) waiting for the input of a user's voice if the recognized instruction is determined to have two or more sub-instructions;

(d) upon receiving the user's voice, recognizing the user's voice and thus a sub-instruction corresponding to the recognized voice and returning to step (b);

(e) upon not recognizing a voice corresponding to any one of the sub-instructions in step (d), displaying the sub-instructions on the touch screen; and

(f) upon selecting one of the sub-instructions on the touch screen, recognizing the selected sub-instruction through coordinates thereof and returning to step (b) and learning a voice for the selected sub-instruction.

It should be appreciated that any prayer or program, can be downloaded onto the humanoid robot 159, and the humanoid robot parts or limbs, hands, fingers, legs, etc., can follow the program or the software by motions doing movements and/or by audio, such as, talking or speaking.

For some applications the sensors in the neck or anywhere in the body of the humanoid robot 159 can be replaced by having timers in the program, such as, on the neck, such that the timer upon activation would turn the motor 120 clockwise or counterclockwise, and once the neck turns, then there could be stops in place of the sensors or switches 124 and 125, such that the motor can turn on until the head reaches the stop, and then the timer in the program would time off and the head would return to its neutral position without using any switches or sensors.

The instructional humanoid robot for teaching and performing a set of instructions could further include a set of instructions, which could be selected from a group comprising of correct manner of performing the Islamic prayer, four Mathahib prayer, Hanafi prayer, Shafi'i prayer, Maliki prayer, Hunbali prayer, Shia Islamic prayer, recitation of Holy Quran, recitation of Holy Bible, recitation of Holy Torah, scientific lecture, educative lecture, a set of instructions programmed by a user, recitation programmed and selected by a user, and a set of movements for said instructional humanoid robot programmed and selected by a user, to name a few.

The instructional humanoid robot can also be programmed to perform any teaching or instructions as desired by the user or an operator. The instructional humanoid robot can also be preprogrammed to perform certain functions via the aid of a computer or similar device. The instructional humanoid robot can also be interactive via instructions and information accessed from a library, databank or similar other program storage device.

The instructional humanoid robot for teaching and performing a set of instructions could further comprise of at least one device 172, 178, and wherein the at least one device 172, 178, could be selected from a group comprising of a USB port, a WiFi circuitry, a DVD player, a CD player, a LED bulb, a speaker, a receiver, a transmitter, a primary display screen, a secondary display screen, to name a few. One or more of the device 172, 178, could be contained inside the humanoid robot 159, or could be located elsewhere, such as, in or around the base 119, screen device 178, to name a few.

### New Embodiments

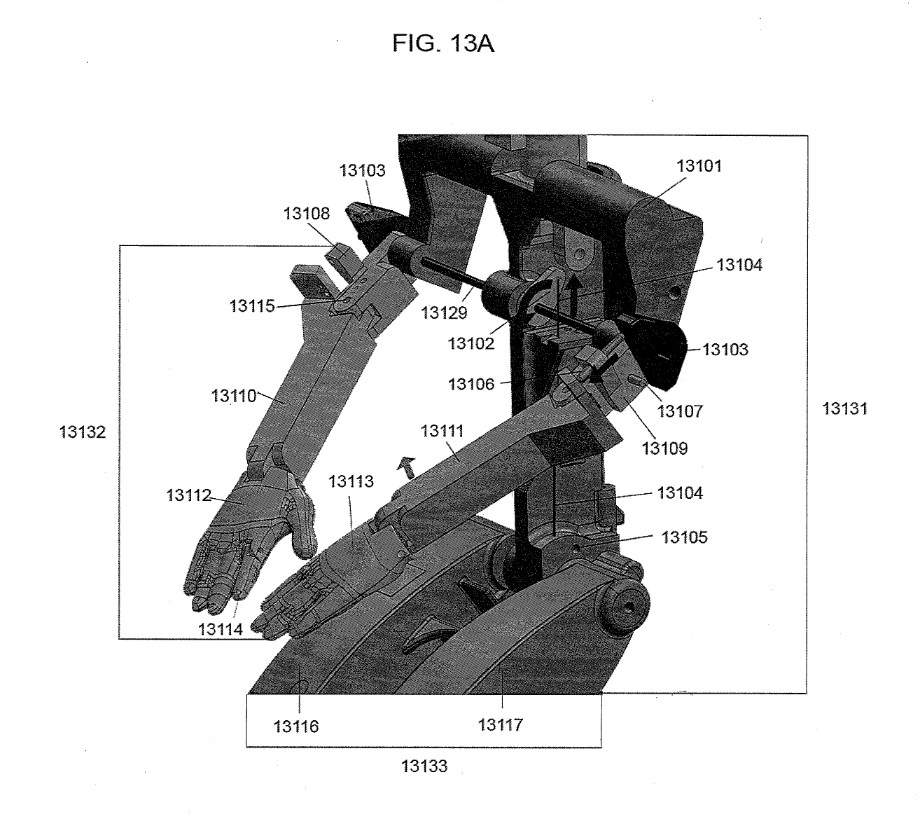

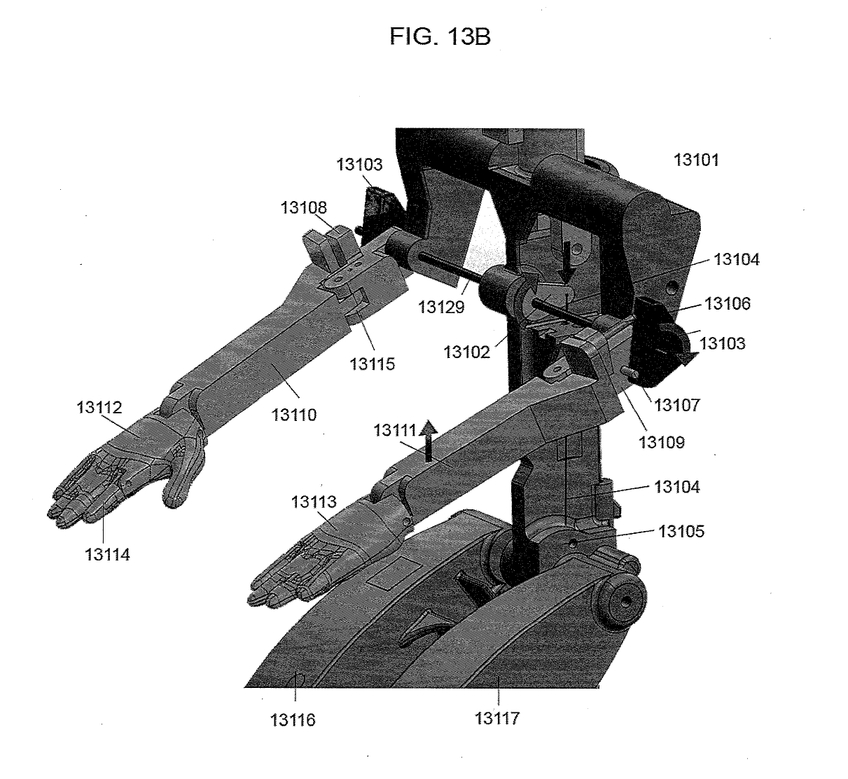

In order to attain further objectives mentioned above, and with reference to FIG. 13A, there is provided in accordance with the present invention, an instructional humanoid robot 13131 for teaching and performing a set of instructions, which includes, but is not limited to, a torso 13101, arms 13132, and legs 13133, whereby the arms 13132 are primarily comprised of a right upper arm 13108, a right forearm 13110 and a right hand 13112 and a left upper arm 13109, a left forearm 13111 and a left hand 13113, respectively, and the legs 13133 are primarily comprised of a right thigh 13116, a right lower leg 13118 and a right foot 13120 and a left thigh 13117, a left lower leg 13119 and a left foot 13121, respectively.

Referring now to the Figures, where FIG. 13A is a top elevation view of an instructional humanoid robot 13131 in accordance to one embodiment of the present invention in which the mechanisms of the torso 13101 and arms 13132 are enlarged to show a method of lowering and crossing the arms 13132. Referring to FIG. 13A where the arms 13132 are connected to the torso 13101 via a pivot point 13133 on the upper side of each the right upper arm 13108 and the upper side of the left upper arm 13109, respectively, allowing them to pivot vertically up and down. The right forearm 13110 is connected to the right upper arm 13108 and left forearm 13111 is connected to the left upper arm 13109, via another pivot point 13115 on the lower side of the right upper arm 13108 and the left upper arm 13109, respectively, allowing them to pivot horizontally in and out. The right hand 13112 is connected to the right forearm 13110 and left hand 13113 is connected to the left forearm 13111 via another pivot point 13115 on the lower side of the right forearm 13110 and the left forearm 13111, respectively, allowing them to pivot vertically up and down. A master actuating rod 13129 passes through a section of the torso 13101 and the pivot point 13115 of the right upper arm 13108 and the left upper arm 13109. Attached to either end of the master actuating rod 13129 is an arm cam 13103 positioned in such a way to actuate an arm crossing pin 13106 and an arm raising pin 13107 on attached to both arms 13132. Located near the middle of the master actuating rod 13129 is a master cam 13102 which controls the rotation of the master actuating rod 13129 and each arm cam 13103. The master cam 13102 is moved by a master cable 13104 which passes through a section of the torso 13101 and is connected to a cable motor 13105 (not shown) located inside the torso 13101 or base 13130 (not shown) of the instructional humanoid robot 13131. A arm crossing pin 13106 is held by a section of the right upper arm 13108 and another arm crossing pin 13106 is held by another section of the left upper arm 13109 in such a way to facilitate the movement of both arms 13132 inwards when actuated by the arm cam 13103 at either end of the master actuating rod 13129. When the cable motor 13105 (not shown) is activated counterclockwise, it unwinds the master cable, which in turn allows a torsion spring 13134 (not shown) located in the torso 13101 to rotate the master cam 13102, the affixed master articulating rod 13129 and the arm cam 13103 on either end of the master articulating rod 13129 counterclockwise. This downward movement causes each arm cam 13103 to apply direct pressure to the arm crossing pin 13106, which in turn pushes a section of each the right forearm 13110 and attached right hand 10114 and the left forearm 13111 and attached left hand 13113 inward and towards one another, each pivoting on a respective pivot point 13115. Each pivot point 13115 contains a torsion spring 13134 (not shown which forces each respective part back to its default positions once tension is no longer applied. This design enables both the downward and crossing movement of the arms 13132 with the counterclockwise rotation of the cable motor 13105 (not shown).

FIG. 13B is a top elevation view of an instructional humanoid robot 13131 in accordance to one embodiment of the present invention in which the mechanisms of the torso 13101 and arms 13132 are enlarged to show a method of raising the arms 13132. Referring to FIG. 13B where an arm raising pin 13107 is affixed to the upper right arm 13108 and the upper left arm 13109, respectively, in such a way that when articulated by each arm cam 13103 on either end of the master articulating rod 13129, the arms are raised. This process is realized when the cable motor 13105 (not shown) is activated clockwise, which winds the master cable, pulling down the master cam 13102 and rotating affixed master articulating rod 13129 and the arm cam 13103 on either end of the master articulating rod 13129 clockwise and downwards. This movement causes each arm cam 13103 to apply direct upward pressure on the arm raising pin 13107 which is affixed to a section of each the right forearm 13110 and the left forearm 13111 upwards, each pivoting on a respective pivot point 13133. This design enables the upward motion of the arms 13132 with the clockwise rotation of the cable motor 13105.

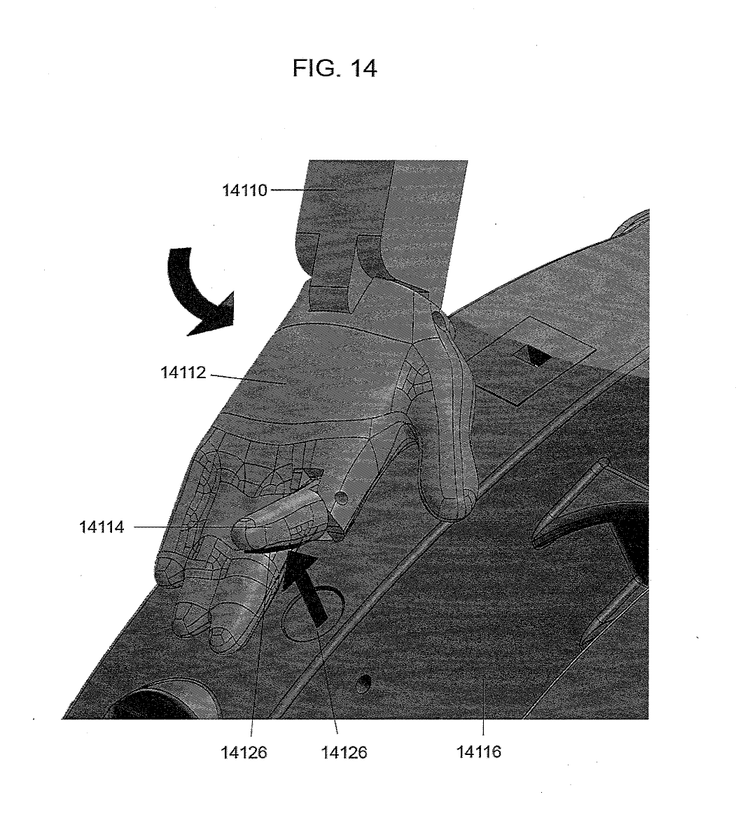

FIG. 14 is a top elevation view of an instructional humanoid robot 13131 in accordance to one embodiment of the present invention in which the mechanisms of the right hand 14112, right forearm 14110 and right thigh 14116 are enlarged to show a method of raising the right index finger 14114. Referring to FIG. 14 where the right hand 14112 is shown resting on the right thigh 14116 with the right index finger 14114 raised. This movement occurs when the cable motor 13105 (not shown) actuates the arms 13132 in such a way that the right hand 14112 is moved over right thigh 14116, causing a magnet 14126 located in the tip in the tip of the right index finger 14114 to be repelled by another magnet 13126 located on the top of the right thigh 14116 and pivot upwards along its respective pivot point 13115. This magnetic polarization keeps the index finger upright until the cable motor 13105 (not shown) actuates the arms 13132 in such a way that the right hand 14112 is moved away from the right thigh 14116.

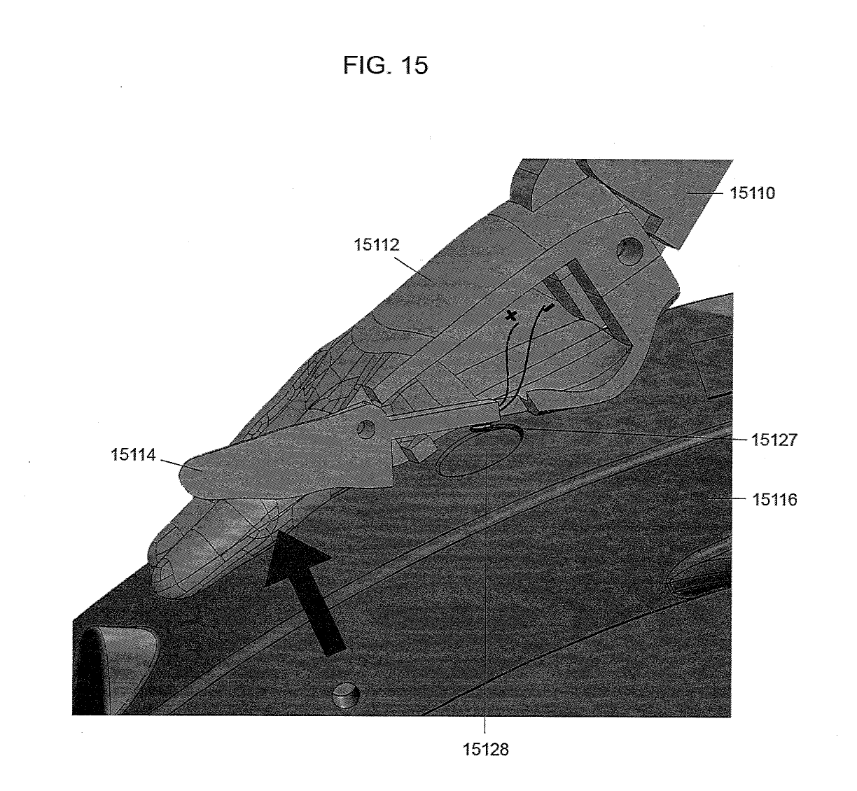

FIG. 15 is a side elevation cross-sectional view of an instructional humanoid robot 13131 in accordance to one embodiment of the present invention in which the mechanisms of the right hand 15112, right forearm 15110 and right thigh 15116 are enlarged to show a method of raising the right index finger. Referring to FIG. 15 where the right hand 15112 is shown resting on the right thigh 1316 with the right index finger 15114 raised. This movement occurs when a magnetic coil 15127 located in the base of the right index finger 15114 is energized, pulling it downward towards a steel piece located on the top of the right thigh 15116 and pivoting the front of the right index finger 15114 upwards. This magnetic polarization keeps the index finger 15114 upright until the magnetic coil 15127 is no longer energized and the right index finger 15114 returns to its default position.

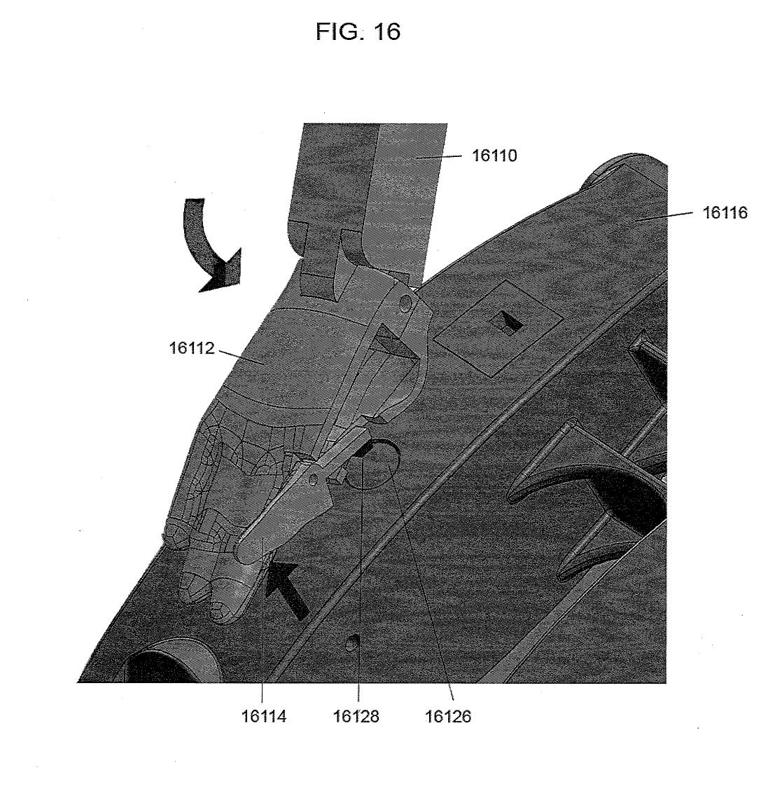

FIG. 16 is a side elevation cross-sectional view of an instructional humanoid robot 13131 in accordance to one embodiment of the present invention in which the mechanisms of the right hand 16112, right forearm 16110 and right thigh 16116 are enlarged to show a method of raising the right index finger. Referring to FIG. 16 where the right hand 16112 is shown resting on the right thigh 16116 with the right index finger 16114 raised. This movement occurs when a magnetic coil 16127 located on the top of the right thigh 16116 is energized, pulling down a steel piece 16128 located in the base of the right index finger 16114 and pivoting the front of the right index finger 16114 upwards. This magnetic polarization keeps the index finger 16114 upright until the magnetic coil 16127 is no longer energized and the right index finger 16114 returns to its default position.

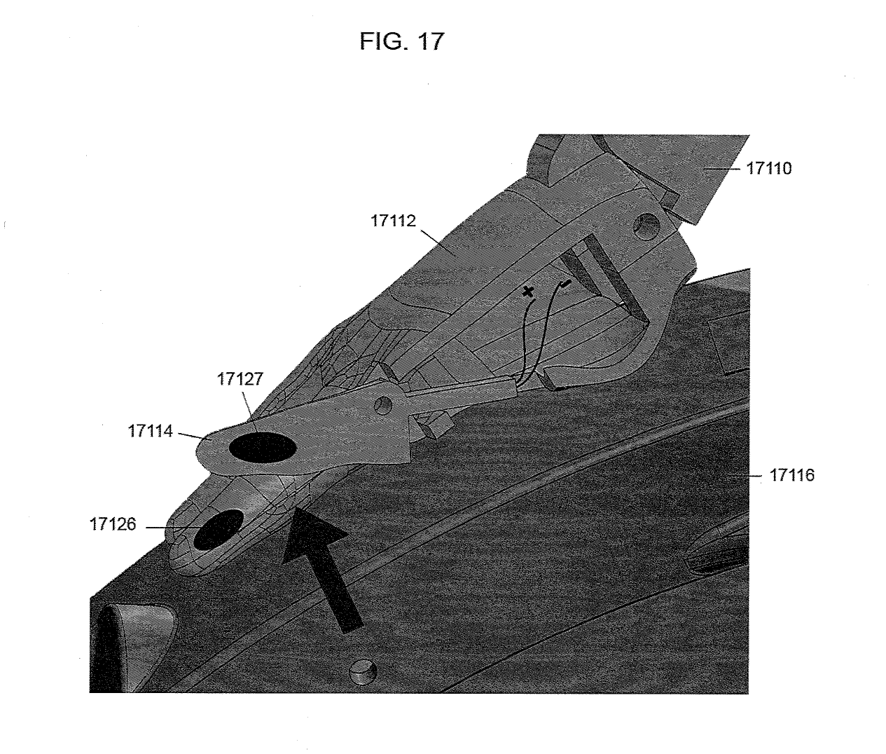

FIG. 17 is a top elevation cross-sectional view of an instructional humanoid robot 13131 in accordance to one embodiment of the present invention in which the mechanisms of the right hand 17112, right forearm 17110 and right thigh 17116 are enlarged to show a method of raising the right index finger. Referring to FIG. 17 where the right hand 17112 is shown resting on the right thigh 17116 with the right index finger 17114 raised. This movement occurs when a magnetic coil 13127 located inside the tip of the right index finger 17144 is energized, and front of the right index finger 17114 is repelled upwards by a magnet 17126 located within the edge of the right hand 17112. This magnetic polarization keeps the index finger 17114 upright until the magnetic coil 17127 is no longer energized and the right index finger 17114 returns to its default position.

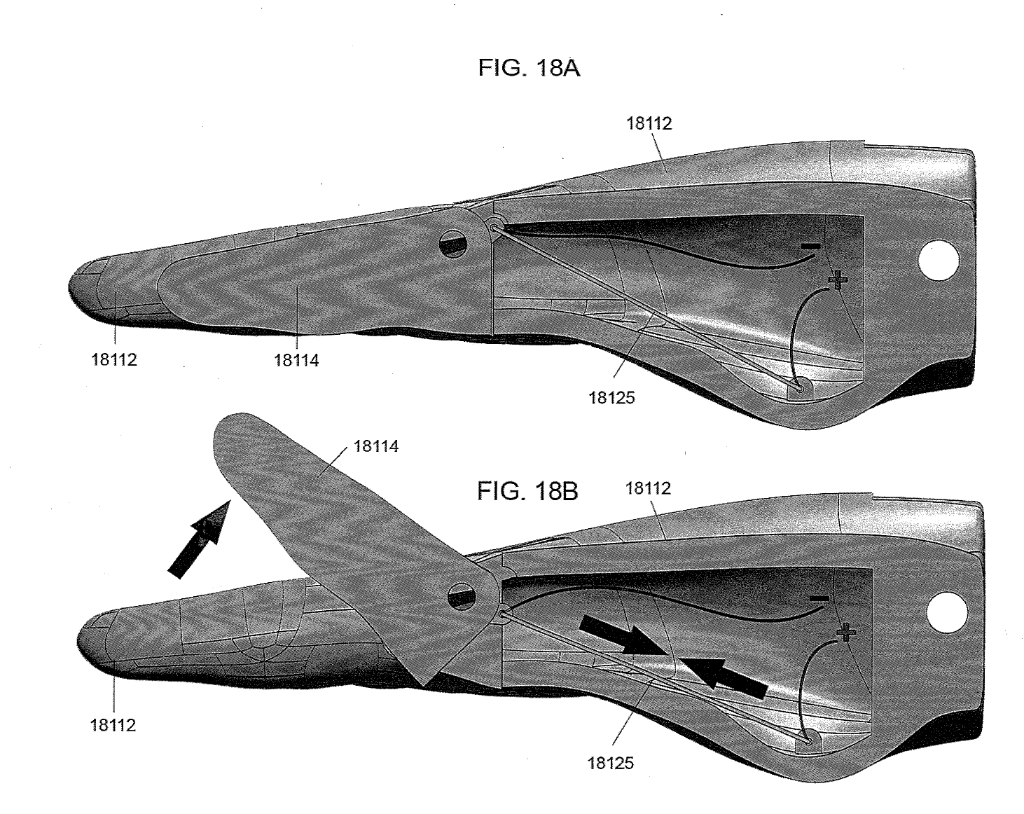

FIG. 18 is a side cross-sectional view of an instructional humanoid robot 13131 in accordance to one embodiment of the present invention in which the mechanisms of the right hand, right hand 18112, right forearm 18110 and right thigh 18116 are enlarged to show a method of raising the right index finger 18114. Referring to FIG. 18 where the right hand 18112 is shown resting on the right thigh 18116 with the right index finger 18114 raised. This movement occurs when a muscle wire 18125 connecting the back of the of the right index finger 18114 to the back of the right hand 18112 is energized and shrinks, pulling the back of the right index finger 18144 downwards and raising the front of the right index finger 18114 upwards, pivoting along its respective pivot point 13115. This magnetic polarization keeps the index finger 18114 upright until the muscle wire 18127 is no longer energized and the right index finger 18114 returns to its default position.

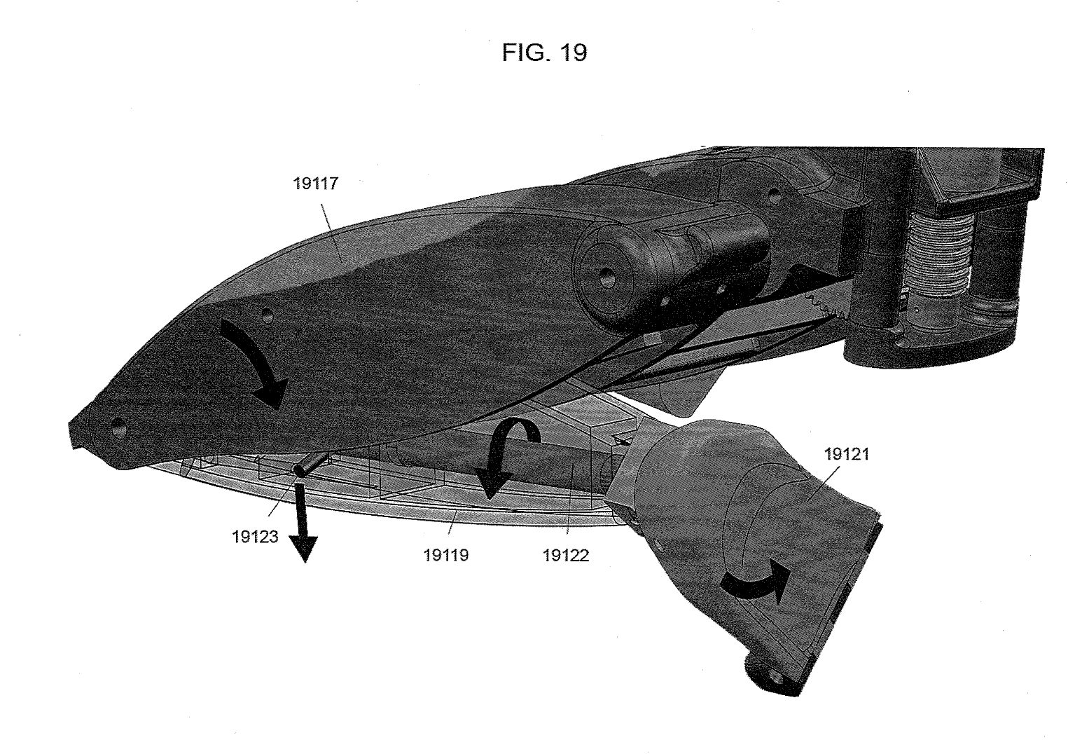

FIG. 19 is side elevation view of an instructional humanoid robot 13131 in accordance to one embodiment of the present invention in which the mechanisms of the left thigh 19117, left lower leg 19119 and left foot 19121 are enlarged to show a method of turning the left foot 19121 underneath the instructional humanoid robot 13131. Referring to FIG. 19 where the left lower leg 19119 contains a rotating leg rod 19122 that is affixed to ankle-portion of the left foot 19121. Attached to the leg rod 19122 is a protruding steel leg pin 19123 which controls the rotation of the leg rod 19122 and the attached left foot 19121. When the left lower leg 19119 begins folding underneath the left thigh 19117 the protruding steel leg pin 19123 hits the side of the left thigh 19117, rotating the leg rod 19122 and turning the left foot 19121 as the instructional humanoid robot 13131 begins moving into a sitting position. A torsion spring 19134 (not shown) located inside the left lower leg 19119 forces the leg rod 19122 and left foot 19121 return to their default position when the instructional humanoid robot 19131 begins rising back to a standing position and the left thigh 19117 is no longer in contact with the protruding steel leg pin 19123.

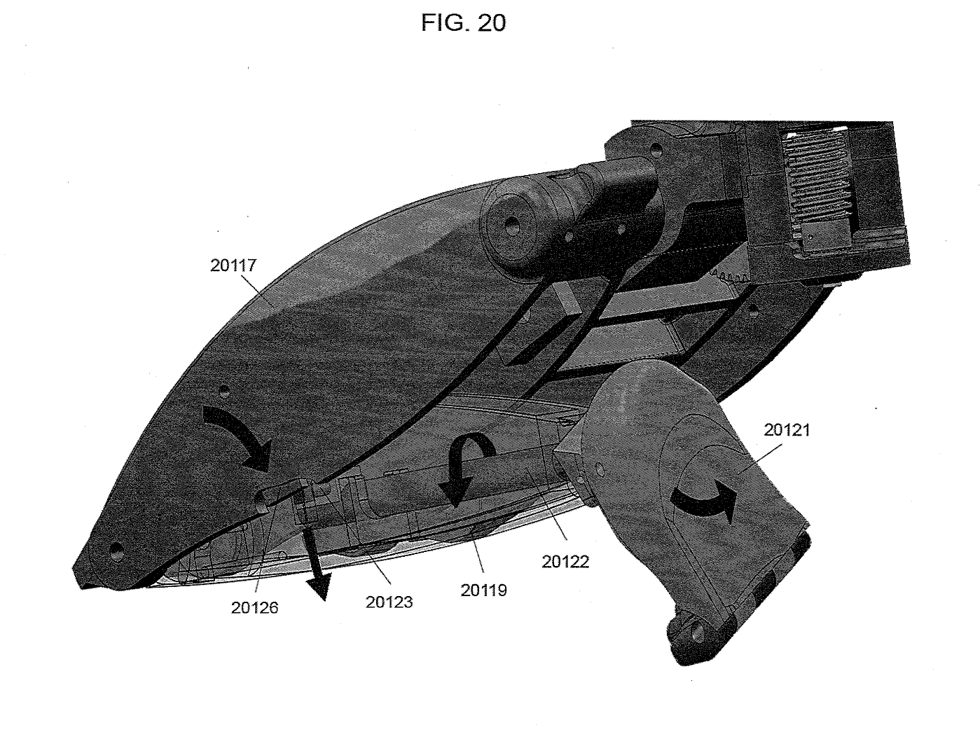

FIG. 20 is side elevation view of an instructional humanoid robot 13131 in accordance to one embodiment of the present invention in which the mechanisms of the left thigh 20117, left lower leg 20119 and left foot 20121 are enlarged to show a method of turning the left foot 20121 underneath the instructional humanoid robot 20131. Referring to FIG. 20 where the left lower leg 20119 contains a rotating leg rod 20122 that is affixed to ankle-portion of the left foot 20121. Attached to the leg rod 20122 is a steel piece 20128 and a magnet 20126 which together control the rotation of the leg rod 20122 and the attached left foot 20121. When the left lower leg 20119 begins folding underneath the left thigh 20117 the steel piece 20128 passes by the magnet 20126 affixed to the inside of the left thigh 20117. The magnetic attraction between the magnet 20126 and the steel piece 20128 causes the leg rod 20122 to rotate and turn the left foot 20121 as the instructional humanoid robot 20131 begins moving into a sitting position. A torsion spring 20134 (not shown) located inside the left lower leg 20119 forces the leg rod 20122 and left foot 20121 return to their default position when the instructional humanoid robot 13131 begins rising back to a standing position and the magnet 20126 in the left thigh 20117 is no longer being magnetically attracting to the steel piece 20128.

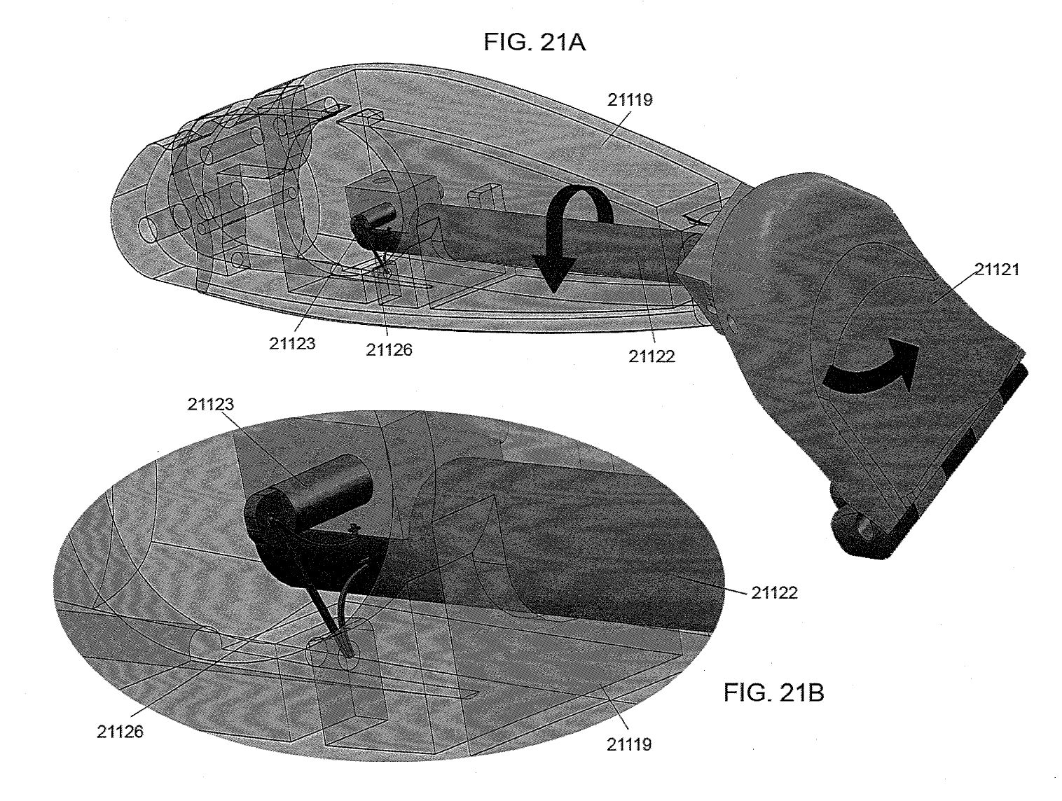

FIGS. 21A and 21B are side elevation views of an instructional humanoid robot 13131 in accordance to one embodiment of the present invention in which the mechanisms of the left thigh 21117, left lower leg 21119 and left foot 21121 are enlarged to show a method of turning the left foot 21121 underneath the instructional humanoid robot 13131. Referring to FIGS. 21a and 21b where the left lower leg 21119 contains a rotating leg rod 21122 that is affixed to ankle-portion of the left foot 21121. Attached to the leg rod 21122 is a steel leg pin 21123 and a muscle wire 21125 which is also connected to the inside of the left lower leg 21119. This muscle wire 21125 controls the rotation of the leg rod 21122 and the attached left foot 21121. When the left lower leg 21119 begins folding underneath the left thigh 21117 the muscle wire 21125 is energized and shrinks, pulling steel pin 21123 downwards and causing the leg rod 21122 to rotate and turn the left foot 21121 as the instructional humanoid robot 21131 begins moving into a sitting position. A torsion spring 21134 (not shown) located inside the left lower leg 21119 forces the leg rod 21122 and left foot 21121 return to their default position when the instructional humanoid robot 21131 begins rising back to a standing position and the muscle wire 21125 in the left lower leg 21119 is no longer being energized.

While the present invention has been particularly described in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. An instructional humanoid robot for teaching and performing a set of instructions, comprising:
a humanoid robot body comprising a core;
a master actuating rod configured to rotate, and at least one means for controlling the rotation of the master actuating rod;
arm crossing pins and arm raising pins, and at least one means for actuating the arm crossing pins and the arm raising pins;
a master cam configured to rotate, and at least one means for controlling the rotation of the master cam;
a master cable configured to wind and unwind, and at least one means for winding and unwinding the master cable;
a right forearm and a left forearm, each forearm configured to rotate in accordance with a position of the arm crossing pins, and each forearm configured to move in a vertical and a horizontal axis, wherein separate means control the vertical movement of the right and left forearms, at least one means controlling an upward movement of the forearms and at least one means controlling a downward movement of the forearms;
a right upper arm and a left upper arm, each upper arm configured to rotate in accordance with a position of the master actuating rod;
a right hand and a left hand, each hand configured to rotate in accordance with a position of a right thigh and a left thigh;
a magnet in the right thigh;
a right lower leg coupled to the right thigh, and a left lower leg coupled to the left thigh; and
a right foot coupled to the right lower leg, and a left foot coupled to the left lower leg, wherein the right foot and the left foot are configured to rotate in accordance with a position of a right and left leg rod, respectively.

2. The instructional humanoid robot of claim 1, wherein said master cable has at least one means to move said forearms.

3. The instructional humanoid robot of claim 1, wherein a right index finger of the right hand is configured to raise.

4. The instructional humanoid robot of claim 3, wherein the right index finger is raised by a magnet in the right thigh.

5. The instructional humanoid robot of claim 3, wherein the right index finger is raised by interaction between a steel piece in the right thigh and a magnetic coil in the right hand.

6. The instructional humanoid robot of claim 3, wherein the right index finger is raised by interaction between a magnetic coil in the right thigh and a steel piece in the index finger.

7. The instructional humanoid robot of claim 3, wherein the right index finger is raised by an electrically actuated muscle wire.

8. The instructional humanoid robot of claim 1, wherein the left lower leg and the left foot are configured to rotate inwards and under the buttocks when the left thigh moves into a sitting position.

9. The instructional humanoid robot of claim 8, wherein the left lower leg and the left foot are rotated inwards and under the buttocks by a steel leg pin.

10. The instructional humanoid robot of claim 8, wherein the left lower leg and the left foot are rotated inwards and under the buttocks by interaction action of a magnet in left thigh and a steel piece in the left lower leg.

11. The instructional humanoid robot of claim 8, wherein the left lower leg and the left foot are rotated inwards and under the buttocks by an electrically actuated muscle wire.
